(19) United States
(12) Patent Application Publication
(10) Pub. No.: US 2025/0147745 A1
(43) Pub. Date: May 8, 2025

(54) QUERY-BACKED CI/CD PIPELINE MODULES AND DISTRIBUTION METHOD

(71) Applicant: Dagger, Inc., Belmont, CA (US)

(72) Inventors: Solomon Hykes, San Francisco, CA (US); Erik Sipsma, San Francisco, CA (US); Andrea Luzzardi, Seattle, WA (US); Sam Alba, Belmont, CA (US)

(21) Appl. No.: 18/936,794

(22) Filed: Nov. 4, 2024

Related U.S. Application Data
(60) Provisional application No. 63/596,338, filed on Nov. 6, 2023.

(51) Int. Cl. G06F 8/61; G06F 9/455

(52) U.S. Cl. CPC G06F 8/61; G06F 9/45508

(57) ABSTRACT

In one embodiment, using a script automation processor hosted using a virtual compute instance and a virtual storage instance associated with media storing sequences of instructions defining an API implementation of an API, a graph server, and programming language runtime interpreters, a method includes obtaining access to a user pipeline automation script comprising sequences of instructions specifying API calls to the API, creating and storing modules extending the API from the user pipeline automation script, wherein some of the modules are re-usable, creating and storing programmatic containers corresponding to the modules, creating and storing a directed acyclic graph (DAG) comprising nodes and edges corresponding to dependencies of the containers, interpreting each module using a particular programming language runtime interpreter among the programming language runtime interpreters, installing the modules in association with the API implementation.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. ©2023 Dagger, Inc.

### BENEFIT CLAIM

This application claims the benefit under 35 U.S.C. § 119 (e) of provisional application 63/596,338, filed 6 Nov. 2023, the entire contents of which are hereby incorporated herein by reference for all purposes as if fully set forth herein.

### TECHNICAL FIELD

One technical field of the present disclosure is computer-implemented methods of deploying computer program applications to distributed computing systems, including cloud-based virtual computing accounts and instances. Another technical field is program-controlled computer process pipeline automation.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Professional software engineering tools have rapidly increased the pace at which computer program applications can be written, debugged, and completed. However, moving applications from development systems to production systems, with the correct configuration of access permissions, compute instances, storage instances, and database connections, continues to be difficult. When developers arrange applications using micro-services that run in programmatic containers, the management of containers adds a layer of complexity. For example, if an application uses one hundred containers, and a developer changes one application segment that is associated with one container having intertwined dependencies upon a dozen other containers, careful change management is required to determine which containers must be redeployed without the time and trouble of redeploying all the containers. When a large number of containers is in play, container management rapidly becomes untenable.

The series of machine steps required to move a completed application to a deployment environment can be termed a pipeline. Developers seek to automate the creation and operation of pipelines. Today, pipeline automation typically requires the laborious authoring of scripts that a script interpreter, command-line interpreter, or shell can interpret and act upon. Examples include bash scripts and python scripts. Some cloud services offer platform-specific support, such as MICROSOFT AZURE DEVOPS, AMAZON AWS with YAML, or Cloud Development Kit (CDK). A script written for one such platform is incompatible with others, yet developers or management may want to change platforms as pricing changes.

The scripts also tend to be customized and difficult to maintain. They tend to be artisanal and immediately accumulate a technology debt upon creation because of the need to maintain them over time, possibly without the availability of those who wrote them. Further, such scripts tend not to be portable; successful use requires having a compatible shell or language interpreter. When applications have dependencies on specific libraries, utilities, or programs, the script must manage these dependencies. If changes in an application change the dependencies, then the script must change.

In some environments, the business of building software involves various workflows: build, lint, test, generate docs, deploy, or release. Each workflow is composed of many inter-connected tasks and must be run frequently. Orchestrating these workflows manually is too time-consuming, so instead, they are automated with scripts. As the project evolves, these scripts tend to cause problems: they stop working, become very slow, or can't be touched because the person who wrote them has left. One approach to this problem is implementing a custom automation platform for the enterprise or a team. This approach usually is disruptive, requires a large up-front cost, and is time-consuming. In the meantime, scripts are frozen and not updated, and when available, teams must adapt to the new platform and migrate scripts that work with other systems.

Based on the foregoing, the referenced technical fields have developed an acute need for better ways to define deployment pipelines, automate deployment pipelines, achieve portability, manage containers, and, in general, simplify and improve the efficiency of application deployment.

### SUMMARY

The appended claims may serve as a summary of the invention.

### BRIEF DESCRIPTION OF THE DRAWINGS

In the drawings:

FIG. 1 illustrates a distributed computer system showing the context of use and principal functional elements with which one embodiment could be implemented.

FIG. 2A and FIG. 2B illustrates a computer-implemented process of creating and instantiating modules for a user pipeline automation script, in one embodiment.

FIG. 3 illustrates a computer system with which one embodiment could be implemented.

### DETAILED DESCRIPTION

In the following description, for the purposes of explanation, numerous specific details are set forth to provide a thorough understanding of the present invention. It will be apparent, however, that the present invention may be practiced without these specific details. In other instances, well-known structures and devices are shown in block diagram form to avoid unnecessarily obscuring the present invention.

The text of this disclosure, in combination with the drawing figures, is intended to state in prose the algorithms that are necessary to program a computer to implement the claimed inventions, at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

One or more different inventions may be described in this disclosure, with alternative embodiments to illustrate examples. Other embodiments may be utilized, and structural, logical, software, electrical, and other changes may be made without departing from the scope of the particular inventions. Various modifications and alterations are possible and expected. Some features of one or more of the inventions may be described with reference to one or more particular embodiments or drawing figures, but such features are not limited to usage in the one or more particular embodiments or figures with reference to which they are described. Thus, the present disclosure is neither a literal description of all embodiments of one or more of the inventions nor a listing of features of one or more of the inventions that must be present in all embodiments.

Headings of sections and the title are provided for convenience but are not intended to limit the disclosure in any way or as a basis for interpreting the claims. Devices that are described as in communication with each other need not be in continuous communication with each other unless expressly specified otherwise. In addition, devices that are in communication with each other may communicate directly or indirectly through one or more intermediaries, logical or physical.

A description of an embodiment with several components in communication with one other does not imply that all such components are required. Optional components may be described to illustrate a variety of possible embodiments and to illustrate one or more aspects of the inventions more fully. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of the described processes may be performed in any order practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment but need not occur only once. Some steps may be omitted in some embodiments or some occurrences, or some steps may be executed more than once in a given embodiment or occurrence. When a single device or article is described, more than one device or article may be used in place of a single device or article. Where more than one device or article is described, a single device or article may be used in place of more than one device or article.

The functionality or features of a device may be alternatively embodied by one or more other devices that are not explicitly described as having such functionality or features. Thus, other embodiments of one or more of the inventions need not include the device itself. Techniques and mechanisms described or referenced herein will sometimes be described in singular form for clarity. However, it should be noted that particular embodiments include multiple iterations of a technique or multiple manifestations of a mechanism unless noted otherwise. Process descriptions or blocks in figures should be understood as representing modules, segments, or portions of code that include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

### 1. General Overview

Embodiments offer an improved alternative to the approaches described in the Background founded on the concept of incremental evolution: Scripts are retained as a means of pipeline automation, but the scripts can be gradually improved by backing them with functions of a script automation processor that are accessible via calls to an application programming interface (API). Further, as a script grows, the developer can segregate the reusable automation logic and move it to an extension of the API, which becomes available for calling in the original script and processing using the script automation processor in the same manner as other API functions. Consequently, the script can remain small and artisanal, but the API grows, so the API becomes an extended and highly useful platform for a developer, team, or community, one script at a time. Scripts do not accumulate technical debt to unavailable authors or become bloated and incomprehensible, and teams are not disrupted by attempts to implement a platform to support script use. The API can be architected to avoid the accumulation of technical debt and to use modularization and other techniques to avoid the problems of prior systems.

Using the script automation processor and API implementations of this disclosure, a complete container instantiation and management engine can be effectively embedded in pipeline automation scripts. Substantive script functions can be orchestrated via calls to a GRAPHQL-based API. Consequently, originally authored pipeline automation scripts can remain compact, by invoking externally implemented functions in API calls. As scripts grow and need to automate more functions, automation logic can be moved out of the script and into modular extensions that add API calls to the script automation processor. Such pipelines are easy to compose, test, change, and evolve. Scripts can import third-party extensions to avoid recoding functionally similar automation functions. Developers continue to script in a familiar scripting language but can leverage a scalable, extensible API linked to an execution engine, with automatic container management. Whenever script code is spun out to an extension, the developer incrementally creates an ever more powerful platform, without having to interrupt script development to create a standalone platform at high front-end cost. Instead, the platform creates itself, in an evolutionary or incremental manner.

Using the script automation processor and API implementations of this disclosure, a user may create a continuous integration and continuous deployment (CI/CD) pipeline. The user may take one piece of the pipeline and turn it into a module or other set of code. A module can be written and used in any language or programming environment. The user may then publish the module to and/or store the module in an online, networked digital data storage repository system, source code management system, or version control management system. The user may design the pipeline as partially re-usable. As a result, another user may import a module, extend the API, and declare high-level descriptions. A module may re-use other modules.

In an embodiment, this disclosure provides a computer system including: a script automation processor; a virtual compute instance and a virtual storage instance associated with one or more non-transitory computer-readable storage media storing one or more first sequences of instructions defining an API implementation of an API, a graph server, and one or more programming language runtime interpreters, and which, when executed using the virtual compute instance, cause the virtual compute instance to execute: obtaining access to a user pipeline automation script including one or more second sequences of instructions specifying one or more API calls to the API; executing the script automation processor; creating and storing one or more modules in one or more programming languages from the user pipeline automation script, the one or more modules extending the API, wherein one or more of the modules are re-usable; creating and storing one or more programmatic containers in memory of the script automation processor, the containers corresponding to the one or more modules; creating and storing a directed acyclic graph (DAG) in the memory of the script processor, the DAG including nodes and edges corresponding to dependencies of the containers; interpreting each of the one or more modules using a particular programming language runtime interpreter among the one or more programming language runtime interpreters; and installing the one or more modules in association with the API implementation.

In some embodiments, the script automation processor further includes the first sequences of instructions which, when executed using the virtual compute instance, cause the virtual compute instance to execute: generating a command line interface (CLI); receiving, via the CLI, an initiation command configured to create a first module; and creating and storing the first module.

In some embodiments, the script automation processor further includes the first sequences of instructions which, when executed using the virtual compute instance, cause the virtual compute instance to execute: receiving, via the CLI, a function calling command configured to execute a function associated with the first module; and executing the function associated with the first module in a programmatic container of the one or more programmatic containers.

In some embodiments, the script automation processor further includes the first sequences of instructions which, when executed using the virtual compute instance, cause the virtual compute instance to execute: receiving, via the CLI, a modification command configured to modify the first module; modifying the first module; and receiving, via the CLI, a synchronization command configured to reload the first module.

In some embodiments, a function associated with the first module is configured to take and return data objects associated with a plurality of types.

In some embodiments, the script automation processor further includes the first sequences of instructions which, when executed using the virtual compute instance, cause the virtual compute instance to execute: receiving, via the CLI, a module calling command configured to add a dependency of a second module to the first module; executing the first module; and during the execution of the first module, calling and executing the second module.

In some embodiments, the first module is stored in two or more repositories. Accordingly, the script automation processor further includes the first sequences of instructions which, when executed using the virtual compute instance, cause the virtual compute instance to execute: receiving, via the CLI, a function calling command specifying a first repository of the two or more repositories; consuming the first module from the first repository; and executing the first module.

In some embodiments, the script automation processor further includes the first sequences of instructions which, when executed using the virtual compute instance, cause the virtual compute instance to execute: receiving, via the CLI, a module publishing command specifying a repository to publish the first module; and publishing the first module in the repository.

In some embodiments, a first function is associated with the first module. The first function is configured to return custom objects defining one or more second functions.

In some embodiments, the script automation processor further includes the first sequences of instructions which, when executed using the virtual compute instance, cause the virtual compute instance to execute: receiving, via the CLI, a function calling command configured to execute the first function; executing the first function; and during the execution of the first function, calling and executing the one or more second functions.

In some embodiments, at least a first function is associated with a first module of the one or more modules. Accordingly, the script automation processor further includes the first sequences of instructions which, when executed using the virtual compute instance, cause the virtual compute instance to execute: executing the first function; and instantiating and returning one or more services from the first function.

In some embodiments, the script automation processor further includes the first sequences of instructions which, when executed using the virtual compute instance, cause the virtual compute instance to execute: creating and storing one or more programmatic service containers in memory of the script automation processor, the service containers corresponding to the one or more services.

In some embodiments, each of the service containers includes a service hostname configured for querying the corresponding service container.

In some embodiments, each of the service containers includes one or more ports configured to expose the corresponding service to a host.

In some embodiments, the script automation processor further includes the first sequences of instructions which, when executed using the virtual compute instance, cause the virtual compute instance to execute: receiving, via one or more of the ports, a request to use the first service from a client on the host; and executing the first service.

In some embodiments, the script automation processor further includes the first sequences of instructions which, when executed using the virtual compute instance, cause the virtual compute instance to execute: binding a first service of the services executing in a first service container of the service container to a client container; and automatically starting the first service when the client container executes.

In some embodiments, a first service of the services executes on a host. Accordingly, the script automation processor further includes the first sequences of instructions which, when executed using the virtual compute instance, cause the virtual compute instance to execute: binding a first container of the containers to the first service; executing the user pipeline automation script to automatically build, test, or deploy a user application in the cloud computing service; and during the executing of the user pipeline automation script, querying the first service by the first container.

In some embodiments, the script automation processor further includes the first sequences of instructions which, when executed using the virtual compute instance, cause the virtual compute instance to execute creating and storing, in the DAG, nodes corresponding the services and edges corresponding to bindings associated with the services.

In some embodiments, the script automation processor further includes two or more programming language runtime interpreters, wherein each programming language runtime interpreter among the two or more programming language runtime interpreters is programmed to interpret a different programming language used in each of the one or more modules.

In some embodiments, the script automation processor further includes the second sequences of instructions which, when executed using the virtual compute instance, cause the virtual compute instance to execute: executing the user pipeline automation script to automatically build, test, or deploy a user application in a cloud computing service; and during the executing, based on the user pipeline automation script, invoking one or more of the one or more modules as part of automatically building, testing, or deploying the user application in the cloud computing service.

In some embodiments, the user pipeline automation script further includes at least one reference to a software development kit (SDK). Accordingly, the script automation processor includes an SDK interface responsive to function invocations via the at least one reference.

In an embodiment, this disclosure provides a computer-implemented method including: using a script automation processor that is hosted using a virtual compute instance and a virtual storage instance associated with one or more non-transitory computer-readable storage media storing one or more first sequences of instructions defining an API implementation of an application programming interface (API), a graph server, and one or more programming language runtime interpreters, obtaining access to a user pipeline automation script including one or more second sequences of instructions specifying one or more API calls to the API; using the script automation processor, creating and storing one or more modules in one or more programming languages from the user pipeline automation script, the one or more modules extending the API, wherein one or more of the modules are re-usable using the script automation processor, creating and storing one or more programmatic containers in memory of the script automation processor, the containers corresponding to the one or more modules; using the script automation processor, creating and storing a directed acyclic graph (DAG) in the memory of the script processor, the DAG including nodes and edges corresponding to dependencies of the containers; using the script automation processor, interpreting each of the one or more modules using a particular programming language runtime interpreter among the one or more programming language runtime interpreters; and using the script automation processor, installing the one or more modules in association with the API implementation.

In an embodiment, this disclosure provides one or more non-transitory computer-readable storage media storing one or more sequences of instructions which, when executed using one or more processors, cause the one or more processors to: using a script automation processor that is hosted using a virtual compute instance and a virtual storage instance associated with one or more non-transitory computer-readable storage media storing one or more first sequences of instructions defining an API implementation of an application programming interface (API), a graph server, and one or more programming language runtime interpreters, obtaining access to a user pipeline automation script including one or more second sequences of instructions specifying one or more API calls to the API; using the script automation processor, creating and storing one or more modules in one or more programming languages from the user pipeline automation script, the one or more modules extending the API, wherein one or more of the modules are re-usable using the script automation processor, creating and storing one or more programmatic containers in memory of the script automation processor, the containers corresponding to the one or more modules; using the script automation processor, creating and storing a directed acyclic graph (DAG) in the memory of the script processor, the DAG including nodes and edges corresponding to dependencies of the containers; using the script automation processor, interpreting each of the one or more modules using a particular programming language runtime interpreter among the one or more programming language runtime interpreters; and using the script automation processor, installing the one or more modules in association with the API implementation.

### 2. Structural & Functional Overview

### 2.1 Distributed Computer System Example

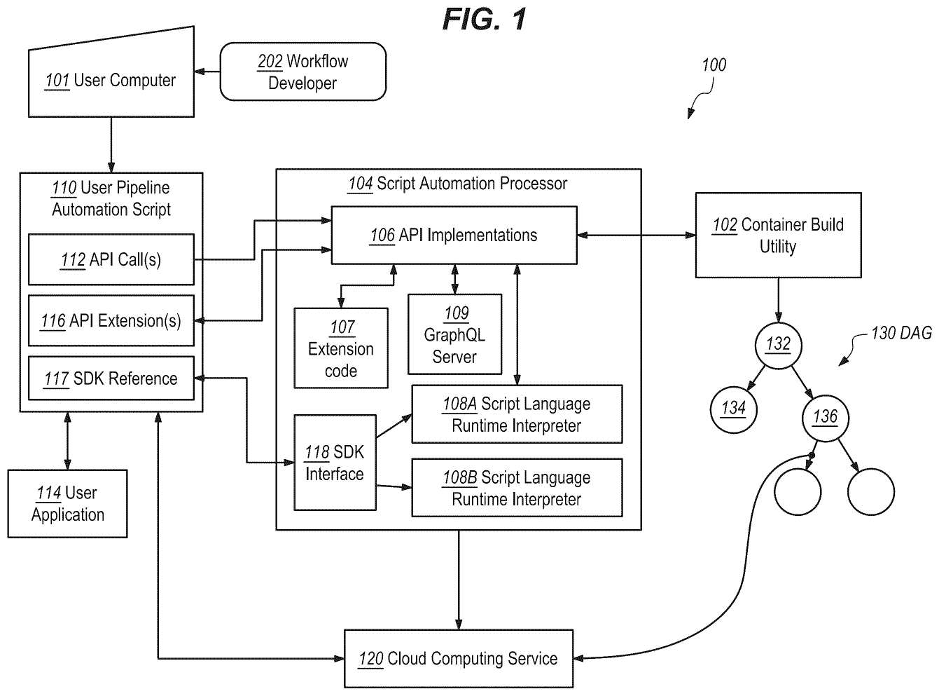

FIG. 1 illustrates a distributed computer system showing the context of use and principal functional elements with which one embodiment could be implemented. In an embodiment, a computer system 100 comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments. FIG. 1 illustrates only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose, and claim a technical system and technical methods in which specially programmed computers, using a special-purpose distributed computer system design, execute functions that have not been available before to provide a practical application of computing technology to the problem of computer-implemented software application pipeline automation. In this manner, the disclosure presents a technical solution to a technical problem, and any interpretation of the disclosure or claims to cover any judicial exception to patent eligibility, such as an abstract idea, mental process, method of organizing human activity or mathematical algorithm, has no support in this disclosure and is erroneous.

Embodiments provide an automation platform for modern software projects. Software builders use the platform to automate their workflows so that they can spend less time fixing artisanal scripts, and more time building. Embodiments make it easy to simplify and modularize existing scripts and to replace them with a modern API and complete developer toolbox.

In one embodiment, a script automation processor is programmed to interpret user scripts including calls to predefined functions, and to automatically create and manage a plurality of containers, organized in a directed acyclic graph or DAG, to reflect dependencies in scripts and user applications. The predefined functions are exposed using an API of the script automation processor, which implements the API functions and can respond to calls of user scripts to execute specified functions. The script automation processor API is a GRAPHQL-compatible API for composing and running powerful pipelines with minimal effort. The use of GRAPHQL queries in part for API access for pipeline automation is unique to this disclosure. By relying on the script automation processor API to do the heavy lifting, one can write a small script that orchestrates a complex workflow, knowing that it will run in a secure and scalable way out of the box, and can easily be changed later as needed. Developers can write an API extension to add new capabilities to the script automation processor API. API extensions are a key differentiating feature of the script automation processor of this disclosure. API extensions ensure that as a workflow grows and evolves, it can remain simple and small, by breaking up its logic into reusable components. API extensions are fully sandboxed, so they can be safely shared and reused between projects. Client workflows may depend on extensions, and extensions may depend on other extensions. Furthermore, embodiments are language-agnostic and can interoperate with scripts written in Javascript, Go, Typescript, and other scripting languages using a language runtime as an adapter.

To execute the instantiation and management of containers to run user applications, one embodiment interoperates with BUILDKIT, a container build utility, to create and build container images. BUILDKIT is commercially available at the time of this writing from Docker, Inc., Palo Alto, California, and is described at the time of this writing at: https://docs.docker.com/develop/develop-images/build_enhancements/. BUILDKIT provides primitive functions that can be called to conduct container management, and its use is illustrated herein for convenience. However, any container runtime can be used, such as containerD.

In an embodiment, the computer system 100 primarily includes a user computer 101, script automation processor 104, and cloud computing service 120. The user computer 101 is associated with a user or enterprise, represented by a workflow developer, that has authored a user application 114 to be deployed to one or more computers or data centers, including for example one or more virtual compute instances and one or more virtual storage instances of the cloud computing service 120. Examples of cloud computing service 120 include AMAZON AWS, MICROSOFT AZURE, GOOGLE CLOUD, and others.

User computer 101 also authors, creates, and stores a user pipeline automation script 110, which can be stored locally or in virtual storage of cloud computing service 120 in association with a cloud service account of the user or an enterprise. In an embodiment, user pipeline automation script 110 comprises script code defining one or more API calls 112, optionally one or more API extensions 116, and a reference 117 to a software development kit (“SDK”). Detailed examples of these elements are provided in other sections herein.

Each of the API calls 112 and API extensions 116 is programmed to call API implementations 106 of script automation processor 104; similarly, the SDK reference 117 causes invoking and/or linking or incorporating an SDK interface 118 of the script automation processor by which the script automation processor uses one or more programming language runtime interpreters 108A, 108B to interpret script code of the user pipeline automation script 110, which can be written in any of several different programming languages, each being compatible with a different one of the programming language runtime interpreters. Examples of programming languages that the programming language runtime interpreters 108A, 108B can be programmed to interpret, in different embodiments, including GO, Typescript, and Bash.

The script automation processor 104 executes using one or more virtual compute instances and virtual storage instances of cloud computing service 120. The API implementations 106 comprise proprietary code to interoperate with cloud computing service 120 and a container build utility 102 to build and deploy the user application 114 to the cloud computing service. In an embodiment, the container build utility 102 is programmed to create and store, in the main memory of the virtual compute instance(s) that host the script automation processor 104, a directed acyclic graph (“DAG”) 130 of container nodes 132, 134, 136. Each of the container nodes 132, 134, and 136 comprises metadata for managing a corresponding programmatic container, such as a DOCKER container. One or more of the API implementations 106 is programmed to interoperate automatically with the container build utility 102 to create such containers as are needed to instantiate and execute the user application 114, including any dependencies, and user pipeline script 110, including any dependencies, in cloud computing service 120. With this architecture, the user computer 101 does not need to manage container instantiation, dependencies, or tear-down directly, as the script automation processor 104 acts as a manager.

For purposes of clearly illustrating one example, in some sections of this disclosure, the shorthand term or label DAGGER or “dagger” refers to the source of a script automation processor 104 and/or one or more of its functional elements. The term or label DAGGER or “dagger” is used merely for convenience to enable referencing the source of code files, paths, directories, and other programmatic constructs using a short word. Other embodiments can implement functionally similar code from other sources having terms, labels, or names other than DAGGER or “dagger.” Similarly, to illustrate a simple user application or app, certain sections of the disclosure use the term TODO or “to do” to identify and signify the functions of an example application. The TODO app could be programmed, for example, to create a “things to do” list of tasks or projects and enable viewing and editing of the tasks. Other embodiments can interoperate with any other substantive user application and the TODO app is presented merely to show one example of how user code can be integrated into and/or interoperate with functional elements of the disclosure.

Once scripts have been created and integrated with API calls and modularized using extensions to move reusable code to the API, with automatic container management, thus moving more and more code to the API and keeping the artisanal query to a manageable size, the automation logic associated with a query can be shared among different teams in the same enterprise or in a different enterprise. In an embodiment, an extension not relating to an external service like Yarn or Netlify can be authored and shared with others. These extensions include elements of a GRAPHQL server 109 and can extend data types and define new API calls. In this manner, one development team can write scripts that load and use extensions that a different team created to implement generic functions that are usable across different substantive applications. Importantly, extensions are sandboxed and must be expressly loaded and associated in a pipeline with other functions of a script. This makes user extensions as safe as loading Go packages, for example.

### 2.2 Example Data Processing Flows

In particular embodiments, the user may utilize DAGGER to create a continuous integration and continuous deployment (CI/CD) pipeline. In one embodiment, the user may take one piece of the pipeline and turn it into a module or other set of code. A module can be written and used in any language or programming environment. The user may then publish the module to and/or store the module in an online, networked digital data storage repository system, source code management system, or version control management system. One commercial example of a repository system is DAGGERVERSE, commercially available from Dagger, Inc. The user may design the pipeline as partially re-usable. As a result, another user may import a module, extend the API, and declare high-level descriptions. In particular embodiments, a module may re-use other modules. The user may have the DAGGER engine run locally and instruct the DAGGER engine to import modules. The user may use a Sync command to instruct DAGGER to reload the module inside the DAGGER engine, rebuild, and reload the module locally. The embodiments disclosed herein also provide support for GPU.

Embodiments can be used in at least two ways: delivering the source of the script automation processor 104 and/or one or more of its functional elements as a CLI (command line interface) tool and using services in the source of a script automation processor 104 and/or one or more of its functional elements. Each is described in the following sections.

### 2.2.1 Dagger As A CLI Tool

In an embodiment, the script automation processor 104 may be more accessible to users, delivered as a CLI tool rather than just a library. The embodiment may include the following features: a major expansion of the DAGGER CLI, removing the need to create a custom CLI for each project; a major expansion of the DAGGER API, with a complete cross-language extension and composition system; and an open ecosystem of reusable content, to take advantage of the extension and composition capabilities of the repository system. A user may use a shell such as bash, zsh, etc., and a containerization system like DOCKER to use the CLI tool based on the script automation processor 104.

In an embodiment, a user may create and initialize a first module with some functions. The user may generate code with the programming language of their choice. The user may create a new directory on their filesystem and run a command dagger mod init to bootstrap their first module:
mkdir potato/cd
potato/
   In the above example command, potato indicates the name of the module.

The above example command may generate a dagger.json module file, an initial main.go source file, as well as a generated dagger.gen.go and internal folder for the generated module code. In one embodiment, the user may run the generated main.go like as below:
dagger call my-function—string-arg ‘Hello daggernauts!’
   or:
echo ‘{potato{myFunction(stringArg: “Hello daggernauts!”){id }}}’|dagger query

In one embodiment, when using dagger call-to-call module functions, the user may not explicitly use the name of the local or remote module. When using dagger call, all names (functions, arguments, struct fields, etc.) may be converted into a shell-friendly “kebab-case” style. When using dagger query and GRAPHQL, all names may be converted into a language-agnostic “camelCase” style.

The user may change the main.go. As illustrated in the above example command, the module was named potato, which means all methods on the potato type are published as functions. The user may replace the template with something simpler:

package main
type Potato struct{ }
func (m *Potato) HelloWorld( ) string {
return “Hello daggernauts!”
}!

The user may then run dagger mod sync to generate their code locally. The user may run this command after every change to their module's interface (for example, when the user adds/removes functions or changes their parameters and return types). In particular embodiments, module functions may be flexible in what parameters they can take. The user may include an optional context.Context, and an optional error result. These below may be all valid variations of the above:
func (m*Potato) HelloWorld ( ) string
func (m*Potato) HelloWorld ( ) (string, error)
func (m*Potato) HelloWorld (ctx context. Context) string
func (m*Potato) HelloWorld (ctx context. Context) (string, error)

To run the new function, once again use dagger call or dagger query:
dagger call hello-world
   or
echo ‘{potato {helloWorld}}’| dagger query

In one embodiment, the user's functions may accept and return multiple different types, not just basic built-in types. For example, to take an object (which the user can use to provide optional parameters or to group large numbers of parameters together):

```
  package main
  import “fmt”
  type Potato struct{ }
  type PotatoOptions struct {
      Count int
      Mashed bool
  }
  func (m *Potato) HelloWorld(opts PotatoOptions) string {
        if opts.Mashed {
      return fmt.Sprintf(“Hello world, I have mashed %d
potatoes”, opts.Count)
        }
    return fmt.Sprintf(“Hello world, I have %d potatoes”,
opts.Count)
  }
```

The user may use—help at the end of dagger call to get help on the commands and flags available. These options can then be set using dagger call or dagger query (exactly as if they had been specified as top-level options). dagger call calls a function using arguments previously described in the snippet of their code. dagger query calls a function with GRAPHQL directly. For example, they can be used as follows:
dagger call hello-world—count 10—mashed true
   or
echo ‘{potato{helloWorld(count: 10, mashed:true)}}’|dagger query

Or the user may return a custom type:

```
  package main
  type Potato struct{ }
  // HACK: to be queried, custom object fields require
‘json‘ tags
  type PotatoMessage struct {
    Message string ‘json:″message″‘
    From string ‘json:″from″‘
  }
    func (msg PotatoMessage) Void( ) { }
  func (m *Potato) HelloWorld(message string) PotatoMessage
{
    return PotatoMessage{
      Message: message,
      From: ″potato@example.com″,
    }
  }
  dagger call hello-world --message ″I am a potato″ message
  dagger call hello-world --message ″I am a potato″ from
or
  echo ′{potato{helloWorld(message: ″I am a
potato″){message, from}}}′ | dagger query
```

In one embodiment, the user may call other modules to install them. Modules may call each other. To add a dependency to the user's module, the user may use dagger mod use:
dagger mod use github. com/userid/daggerverse/helloWorld @26f8ed9f1748ec8c9345281add850fd392441990

This module may be added to the user's dagger.json:
“dependencies”: [
“github.com/userid/daggerverse/helloWorld@26f8ed9f1748ec8c9345281add850fd392441990”]

The user can also use local modules as dependencies. However, they must be stored in a sub-directory of your module. For example:
dagger mod use./path/to/module

The module may be added to the user's code generation so the user can access it from their own module's code:

```
  func (m *Potato) HelloWorld(ctx context.Context) (string,
error) {
    return dag.HelloWorld( ).Message(ctx)
  }
```

In one embodiment, the user can consume modules from a plurality of different sources. One way to dagger use, dagger call, or dagger query a module may be to reference it by its GitHub URL (similar to Go package strings). For example:

```
  dagger call test -m “github.com/user/repo@main”
or
  dagger query -m “github.com/user/repo@main” << EOF
    query test {
      ...
    }
  EOF
```

Or, if the user's module is in a subdirectory of the Git repository:

```
  dagger call test -m
“github.com/user/repo/subdirectory@main”
or
  dagger query -m “github.com/user/repo/subdirectory@main”
<<EOF
    query test {
      ...
    }
  EOF
```

The user can also use modules from the local disk, without needing to push them to a repository.

```
  dagger call test -m “./path/to/module”
or
  dagger query -m “./path/to/module” <<EOF
    query test {
      ...
    }
  EOF
```

In one embodiment, the user may publish their own modules. The user can publish their own modules to the repository, so that other users can easily discover them. The data may be stored and fetched from GitHub. To publish a module, the user may create a Git repository for it and push it to GitHub:
#assuming the user's module is in “potato/”
git init
git add potato/
git commit-m “Initial commit”
git remote add origin
git@github.com:<user>/daggerverse.git
git push origin main

The user may then navigate to https://daggerverse.dev, and use the top-module bar to paste the GitHub link to their module (github.com/<user>/daggerverse.git), then click “Crawl”. The user may use other names instead of daggerverse as the name of their Git repository. Using daggerverse may allow all their modules to be in one Git repository together. But the user can always split them out into separate repositories, or name it something different.

In one embodiment, the user's functions can return custom objects, which in turn can define new functions. This allows for “chaining” of functions in the same style as the core Dagger API. Chaining can enable the user to call functions and then call functions behind the called function, which may return the module itself. As long as the user's object can be JSON-serialized by their SDK, its state may be preserved and passed to the next function in the chain.

Here is an example module using the Go SDK:

```
  // A dagger module for saying hello world!
  package main
    import (
      “context”
      “fmt”
    )
  type HelloWorld struct {
    Greeting string
    Name string
  }
  func (hello *HelloWorld) WithGreeting(ctx
context.Context, greeting string) (*HelloWorld, error) {
    hello.Greeting = greeting
    return hello, nil
  }
  func (hello *HelloWorld) WithName(ctx context.Context,
name string) (*HelloWorld, error) {
    hello.Name = name
    return hello, nil
  }
  func (hello *HelloWorld) Message(ctx context.Context)
(string, error) {
    var (
      greeting = hello.Greeting
      name = hello.Name
    )
    if greeting == “” {
      greeting = “Hello”
    }
    if name == “” {
      name = “World”
    }
    return fmt.Sprintf(“%s, %s!”, greeting, name), nil
  }
```

And here is an example query for this module. The chaining call of functions described above in Go language is translated into GRAPHQL query.

```
{
  helloWorld {
    message
    withName(name: “Monde”) {
      withGreeting(greeting: “Bonjour”) {
        message
        }
      }
    }
}
```

The result may be:

```
{
  “helloWorld”: {
    “message”: “Hello, World!”,
    “withName”: {
    “withGreeting”: {
      “message”: “Bonjour, Monde!”
      }
    }
  }
}
```

In one embodiment, the context and error return may be optional in the module's function signature. The user may remove them if they don't need them. A module's private fields may not be persisted.

In one embodiment, the user may rerun commands with—focus=false. Sometimes, user logs may collapse and may not contain all the information from a failure. To make sure that logs aren't automatically collapsed, the user can run any dagger subcommand with the—focus=false flag to disable this behavior.

In one embodiment, the user may access the docker logs. The Dagger Engine may run in a dedicated container. The user can find the container:
DAGGER_ENGINE_DOCKER_CONTAINER=“$(docker container list—all—filter ‘name=\hat{ }dagger-engine-*’—format‘{{.Names}}’)”

The user can then access the logs for the container:
docker logs $DAGGER_ENGINE_DOCKER_CONTAINER

### 2.2.2 Using Services in Dagger

In one embodiment, the user can use services in the source of a script automation processor 104 and/or one or more of its functional elements. Services may comprise long-running containers. The user may have full control of services with container-to-container networking. The script automation processor 104 may bind service containers.

The Container.withServiceBinding API may take a Service instead of a Container, so the user may call Container.asService on its argument.

The script automation processor 104 may provide service containers, aka container-to-container networking. This feature may enable users to spin up additional long-running services (as containers) and communicate with those services from their DAGGER pipelines. The script automation processor 104 further provides support for container-to-host networking and host-to-container networking.

Some example use cases for services and service containers are running a test database, running end-to-end integration tests, and running sidecar services.

The service containers provided by the embodiments disclosed herein have the following characteristics. Each service container may have a canonical, content-addressed hostname and an optional set of exposed ports. Service containers can bind to other containers as services.

Service containers may come with the following built-in features. Service containers may be started just in time, de-duplicated, and stopped when no longer needed. Service containers may be health-checked prior to running clients. Service containers may be given an alias for the client container to use as its hostname.

In one embodiment, the user can work with service hostnames and ports. Each service container may have a canonical, content-addressed hostname and an optional set of exposed ports.

For example, for the Go development environment, the user can query a service container's canonical hostname by calling the Service. Hostname( ) SDK method:

```
  package main
    import (
      “context”
      “fmt”
      “os”
      “dagger.io/dagger”
    )
  func main( ) {
    ctx := context.Background( )
    // create Dagger client
    client, err := dagger.Connect(ctx,
dagger.WithLogOutput(os.Stderr))
    if err != nil {
      panic(err)
    }
    defer client.Close( )
    // get hostname of service container via API
    val, err := client.Container( ).
      From(“python”).
      WithExec([ ]string{“python”, “-m”,
“http.server”}).
      AsService( ).
      Hostname(ctx)
    if err != nil {
      panic(err)
    }
    fmt.Println(val)
  }
```

For example, for the Node.js development environment, the user can query a service container's canonical hostname by calling the Service.hostname( ) SDK method:

```
  import { connect, Client } from “@dagger.io/dagger”
    connect(
      async (client: Client) => {
        // get hostname of service container
        const val = await client
          .container( )
          .from(“python”)
          .withExec([“python”, “-m”,
“http.server”])
          .asService( )
          .hostname( )
        console.log(val)
        },
        { LogOutput: process.stderr }
    )
```

For example, for the Python development environment, the user can query a service container's canonical hostname by calling the Service.hostname( ) SDK method:

```
  import sys
  import anyio
  import dagger
  async def main( ):
    # create Dagger client
    async with
dagger.Connection(dagger.Config(log_output=sys.stderr)) as
client:
      # get hostname of service container via API
      val = await (
        client.container( )
        .from_(“python”)
        .with_exec([“python”, “-m”, “http.server”])
        .asService( )
        .hostname( )
      )
    print(val)
  anyio.run(main)
```

In one embodiment, the user can also define the ports on which the service container will listen. DAGGER may check the health of each exposed port prior to running any clients that use the service so that clients don't have to implement their own polling logic. The following example uses the WithExposedPort( ) method to set ports on which the service container will listen. This example may also use the Endpoint( ) helper method, which returns an address pointing to a particular port, optionally with a URL scheme. The user can either specify a port or let DAGGER pick the first exposed port.

An example of pseudo-code for the Go development environment is shown below.

```
  package main
  import (
    “context”
    “fmt”
    “os”
    “dagger.io/dagger”
  )
  func main( ) {
    ctx := context.Background( )
    // create Dagger client
    client, err := dagger.Connect(ctx,
dagger.WithLogOutput(os.Stderr))
    if err != nil {
      panic(err)
    }
    defer client.Close( )
    // create HTTP service container with exposed port
8080
    httpSrv := client.Container( ).
      From(“python”).
      WithDirectory(“/srv”,
client.Directory( ).WithNewFile(“index.html”, “Hello, world!”)).
      WithWorkdir(“/srv”).
      WithExec([ ]string{“python”, “-m”, “http.server”,
“8080”}).
      WithExposedPort(8080).
      AsService( )
    // get endpoint
    val, err := httpSrv.Endpoint(ctx)
      if err != nil {
        panic(err)
      }
      fmt.Println(val)
      // get HTTP endpoint
      val, err = httpSrv.Endpoint(ctx,
dagger.ServiceEndpointOpts{
        Scheme: “http”,
      })
      if err != nil {
        panic(err)
      }
      fmt.Println(val)
    }
```

An example of pseudo-code for the Node.js development environment is shown below.

```
  import { connect, Client } from “@dagger.io/dagger”
  connect(
    async (client: Client) => {
      // create HTTP service container with exposed port
8080
      const httpSrv = client
        .container( )
        .from(“python”)
        .withDirectory(
        “/srv”,
        client.directory( ).withNewFile(“index.html”,
“Hello, world!”)
      )
      .withWorkdir(“/srv”)
      .withExec([“python”, “-m”, “http.server”, “8080”])
      .withExposedPort(8080)
      .asService( )
      // get HTTP endpoint
      let val = await httpSrv.endpoint( )
      console.log(val)
      val = await httpSrv.endpoint({ scheme: “http” })
      console.log(val)
      },
      { LogOutput: process.stderr }
  )
```

An example of pseudo-code for the Python development environment is shown below.

```
  import sys
  import anyio
  import dagger
  async def main( ):
    # create Dagger client
    async with
dagger.Connection(dagger.Config(log_output=sys.stderr)) as
client:
      # create HTTP service container with exposed port
8080
      http_srv = (
        client.container( )
        .from_(“python”)
        .with_directory(
          “/srv”,
  client.directory( ).with_new_file(“index.html”, “Hello,
world!”),
        )
        .with_workdir(“/srv”)
        .with_exec([“python”, “-m”, “http.server”,
“8080”])
        .with_exposed_port(8080)
        .asService( )
      )
      # get endpoint
      val = await http_srv.endpoint( )
      # get HTTP endpoint
      val_scheme = await
http_srv.endpoint(scheme=“http”)
      print(val)
      print(val_scheme)
  anyio.run(main)
```

In particular embodiments, the user may set their own hostname aliases with service bindings. The user may use services in DAGGER in the following ways: binding service containers, exposing service containers to the host, and exposing host services to client containers.

DAGGER may enable users to bind a service running in a container to another (client) container with an alias that the client container can use as a hostname to communicate with the service. Binding a service to a container or the host may create a dependency in the user's DAGGER pipeline. The service container may be running when the client container runs. The bound service container may be started automatically whenever its client container runs.

The following is an example of an HTTP service automatically starting in tandem with a client container. The service binding may enable the client container to access the HTTP service using the alias www.

The example pseudocode for the Go development environment is shown below.

```
  package main
  import (
    “context”
    “fmt”
    “os”
    “dagger.io/dagger”
  )
  func main( ) {
    ctx := context.Background( )
    // create Dagger client
    client, err := dagger.Connect(ctx,
dagger.WithLogOutput(os.Stderr))
    if err != nil {
      panic(err)
    }
    defer client.Close( )
    // create HTTP service container with exposed port
8080
    httpSrv := client.Container( ).
      From (“python”).
      WithDirectory(“/srv”,
client.Directory( ).WithNewFile(“index.html”, “Hello, world!”)).
      WithWorkdir(“/srv”) .
      WithExec([ ]string {“python”, “-m”, “http.server”,
“8080”}).
      WithExposedPort(8080).
      AsService( )
    // create client container with service binding
    // access HTTP service and print result
    val, err := client.Container( ).
      From(“alpine”).
      WithServiceBinding(“www”, httpSrv).
      WithExec([ ]string{“wget”, “-O-”,
“http://www:8080”}).
      Stdout (ctx)
    if err != nil {
      panic(err)
    }
    fmt.Println(val)
  }
```

An example of pseudo-code for the Node.js development environment is shown below.

```
  import { connect, Client } from “@dagger.io/dagger”
  connect(
    async (client: Client) => {
      // create HTTP service container with exposed
port 8080
      const httpSrv = client
        .container( )
        .from(“python”)
        .withDirectory(
        “/srv”,
        client.directory( ).withNewFile(“index.html”,
“Hello, world!”)
  )
  .withWorkdir(“/srv”)
  .withExec([“python”, “-m”, “http.server”, “8080”])
  .withExposedPort(8080)
  .asService( )
  // create client container with service binding
  // access HTTP service and print result
  const val = await client
    .container( )
    .from(“alpine”)
    .withServiceBinding( “www”, httpSrv)
    .withExec([“wget”, “-qO-”, “http://www:8080”])
    .stdout( )
  console.log(val)
  },
  { LogOutput: process.stderr }
  )
```

An example of pseudo-code for the Python development environment is shown below.

```
  import sys
  import anyio
  import dagger
  async def main( ):
    # create Dagger client
    async with
dagger.Connection(dagger.Config(log_output=sys.stderr)) as
client:
      # create HTTP service container with exposed port
8080
      http_srv = (
        client.container( )
        .from_(“python”)
        .with_directory(
          “/srv”,
  client.directory( ).with_new_file(“index.html”, “Hello,
world!”),
        )
        .with_workdir(“/srv”)
        .with_exec([“python”, “-m”, “http.server”,
“8080”])
        .with_exposed_port(8080)
        .as_service( )
      )
      # create client container with service binding
      # access HTTP service and print result
      val = await (
        client.container( )
        .from_(“alpine”)
        .with_service_binding(“www”, http_srv)
        .with_exec([“wget”, “-O-”,
“http://www:8080”])
        .stdout( )
      )
    print(val)
  anyio.run(main)
```

In particular embodiments, services in service containers may be configured to listen on the IP address 0.0.0.0 instead of 127.0.0.1. This may be because 127.0.0.1 may be only reachable within the container itself, so other services (including the DAGGER health check) may not be able to connect to it. Using 0.0.0.0 may allow connections to and from any IP address, including the container's private IP address in the DAGGER network.

When a service is bound to a container, it also conveys to any outputs of that container, such as files or directories. The service may be started whenever the output is used, so one can also do things like the below example pseudo-code. An example of pseudo-code for the Go development environment is below.

```
  package main
  import (
    “context”
    “fmt”
    “os”
    “dagger.io/dagger”
  )
  func main( ) {
    ctx := context.Background( )
    // create Dagger client
    client, err := dagger.Connect(ctx,
dagger.WithLogOutput(os.Stderr))
    if err != nil {
      panic(err)
    }
    defer client.Close( )
    // create HTTP service container with exposed port
8080
    httpSrv := client.Container( ).
      From(“python”).
      WithDirectory(“/srv”,
client.Directory( ).WithNewFile(“index.html”, “Hello, world!”)).
      WithWorkdir(“/srv”).
      WithExec([ ]string{“python”, “-m”, “http.server”,
“8080”}).
      WithExposedPort(8080).
      AsService( )
    // create client container with service binding
    // access HTTP service, write to file and retrieve
contents
    val, err := client.Container( ).
      From(“alpine”).
      WithServiceBinding(“www”, httpSrv).
      WithExec([ ]string{“wget”, “http://www:8080”}).
      File(“index.html”).
      Contents(ctx)
    if err != nil {
      panic(err)
    }
    fmt.Println(val)
  }
```

An example of pseudo-code for the Node.js development environment is shown below.

```
  import { connect, Client } from “@dagger.io/dagger”
  connect (
    async (client: Client) => {
    // create HTTP service container with exposed port
8080
      const httpSrv = client
      .container( )
      .from(“python”)
      .withDirectory(
      “/srv”,
      client.directory( ).withNewFile(“index.html”,
“Hello, world!”)
    )
      .withWorkdir(“/srv”)
      .withExec([“python”, “-m”, “http.server”,
“8080”])
      .withExposedPort(8080)
      .asService( )
    // create client container with service binding
    // access HTTP service, write to file and retrieve
contents
    const val = await client
      .container( )
      .from(“alpine”)
      .withServiceBinding(“www”, httpSrv)
      .withExec([“wget”, “http://www:8080”])
      .file(“index.html”)
      .contents( )
    console.log(val)
    },
  { LogOutput: process.stderr }
  )
```

An example of pseudo-code for the Python development environment is shown below.

```
  import sys
  import anyio
  import dagger
  async def main( ):
    # create Dagger client
    async with
dagger.Connection(dagger.Config(log_output=sys.stderr)) as
client:
    # create HTTP service container with exposed port 8080
    http_srv = (
      client.container( )
      .from_(“python”)
      .with_directory(
        “/srv”,
  client.directory( ).with_new_file(“index.html”, “Hello,
world!”),
      )
      .with_workdir(“/srv”)
      .with_exec([“python”, “-m”, “http.server”,
“8080”])
      .with_exposed_port(8080)
      .as_service( )
    )
    # create client container with service binding
    # access HTTP service, write to file and retrieve
contents
    val = await (
      client.container( )
      .from_(“alpine”)
      .with_service_binding(“www”, http_srv)
      .with_exec([“wget”, “http://www:8080”])
      .file(“index.html”)
      .contents( )
      )
    print(val)
  anyio.run(main)
```

In one embodiment, the user may expose service container ports directly to the host. This may enable clients on the host to communicate with services running in DAGGER. One use case is for testing, where the user may be able to spin up ephemeral databases to run tests against. The user may also use this to access a web UI in a browser on their desktop. The following is an example of how to use DAGGER services on the host. In this example, the host makes HTTP requests to an HTTP service running in a container. An example of pseudo-code for the Go development environment is shown below.

```
  package main
  import (
    “context”
    “fmt”
    “io”
    “net/http”
    “os”
    “dagger.io/dagger”
  )
  func main( ) {
    ctx := context.Background( )
    // create Dagger client
    client, err := dagger.Connect(ctx,
dagger.WithLogOutput(os.Stderr))
    if err != nil {
      panic(err)
    }
    defer client.Close( )
    // create HTTP service container with exposed port
8080
    httpSrv := client.Container( ).
      From (“python”).
        WithDirectory(“/srv”,
client.Directory( ).WithNewFile(“index.html”, “Hello, world!”)).
        WithWorkdir(“/srv”).
        WithExec([ ]string{“python”, “-m”,
“http.server”, “8080”}).
        WithExposedPort(8080).
        AsService( )
    // expose HTTP service to host
    tunnel, err :=
client.Host( ).Tunnel (httpSrv).Start(ctx)
    if err != nil {
      panic(err)
    }
    defer tunnel.Stop(ctx)
    // get HTTP service address
    srvAddr, err := tunnel.Endpoint(ctx)
    if err != nil {
      panic(err)
    }
    // access HTTP service from host
    res, err := http.Get(“http://” + srvAddr)
    if err != nil {
      panic(err)
    }
    defer res.Body.Close( )
    // print response
    body, err := io.ReadAll(res.Body)
    if err != nil {
      panic(err)
    }
    fmt.Println(string(body))
  }
```

An example of pseudo-code for the Node.js development environment is shown below.

```
  import { connect, Client } from “@dagger.io/dagger”
  import fetch from “node-fetch”
  connect(
    async (client: Client) => {
        // create HTTP service container with exposed port
8080
        const httpSrv = client
          .container( )
          .from(“python”)
          .withDirectory(
            “/srv”,
            client.directory( ).withNewFile(“index.html”,
“Hello, world!”)
          )
          .withWorkdir(“/srv”)
          .withExec([“python”, “-m”, “http.server”, “8080”])
          .withExposedPort(8080)
          .asService( )
        // expose HTTP service to host
        const tunnel = await
client.host( ).tunnel(httpSrv).start( )
        // get HTTP service address
        const srvAddr = await tunnel.endpoint( )
        // access HTTP service from host
      // print response
        await fetch (“http://” + srvAddr)
          .then((res) => res.text( ))
          .then((body) => console.log(body))
    },
    { LogOutput: process.stderr }
  )
```

An example of pseudo-code for the Python development environment is shown below.

```
  import sys
  import anyio
  import httpx
  import dagger
  async def main( ):
    # create Dagger client
    async with
dagger.Connection(dagger.Config(log_output=sys.stderr)) as
client:
      # create HTTP service container with exposed port
8080
      http_srv = (
        client.container( )
        .from_(“python”)
        .with_directory(
            “/srv”,
client.directory( ).with_new_file(“index.html”, “Hello, world!”),
        )
        .with_workdir(“/srv”)
        .with_exec([“python”, “-m”, “http.server”,
“8080”])
        .with_exposed_port(8080)
        .as_service( )
      )
      # expose HTTP service to host
      tunnel = await
client.host( ).tunnel(http_srv).start( )
      # get HTTP service address
      endpoint = await tunnel.endpoint( )
      # access HTTP service from host
      async with httpx.AsyncClient( )as http:
        r = await http.get(f“http://{endpoint}”)
        print(r.status_code)
        print(r.text)
  anyio.run(main)
```

In one embodiment, the DAGGER pipeline may call host.tunnel (service).start( ) to create a new Service. By default, DAGGER may let the operating system randomly choose which port to use based on the available ports on the host's side. Finally, a call to Service.endpoint( ) may get the final address with whichever port is bound.

In one embodiment, the user can expose host services to containers. The user may bind containers to host services. This may enable client containers in DAGGER pipelines to communicate with services running on the host. A service may be already listening on a port on the host, out-of-band of DAGGER.

The following is an example of how a container running in a DAGGER pipeline can access a service on the host. In this example, a container in a DAGGER pipeline queries a MariaDB database service running on the host. Before running the pipeline, the user may use the following command to start a MariaDB database service on the host:
docker run—rm—detach-p 3306:3306—name my-mariadb—env MARIADB_ROOT_PASSWORD=secret mariadb:10.11.2

An example of pseudo-code for the Go development environment is shown below.

```
  package main
  import (
    “context”
    “fmt”
    “os”
    “dagger.io/dagger”
  )
  func main( ) {
    ctx := context.Background( )
    //create Dagger client
    client, err := dagger.Connect(ctx,
dagger.WithLogOutput(os.Stderr))
    if err != nil {
      panic(err)
    }
    defer client.Close( )
    // expose host service on port 3306
    hostSrv :=
client.Host( ).Service([ ]dagger.Port Forward{
      {Frontend: 3306, Backend: 3306} ,
    })
    // create MariaDB container
    // with host service binding
    // execute SQL query on host service
    out, err := client.Container( ).
      From (“mariadb:10.11.2”).
      WithServiceBinding(“db”, hostSrv).
      WithExec([ ]string {“/bin/sh”, “-c”,
“/usr/bin/mysql -- user-root --password=secret --host=db -e
‘SELECT * FROM mysql.user’”}).
      Stdout(ctx)
    if err != nil {
      panic(err)
    }
    fmt.Println(out)
  }
```

An example of pseudo-code for the Node.js development environment is shown below.

```
  import { connect, Client } from “@dagger.io/dagger”
  connect (
    async (client: Client) => {
      // expose host service on port 3306
      const hostSrv = client.host( ).service([{ frontend:
3306, backend: 3306 }])
      // create MariaDB container
      // with host service binding
      // execute SQL query on host service
      const out = await client
        .container( )
        .from(“mariadb: 10.11.2”)
        .withServiceBinding(“db”, hostSrv)
        .withExec([
          “/bin/sh”,
          “-c”,
          “/usr/bin/mysql --user=root --password=secret --
host=db -e ‘SELECT * FROM mysql.user’”,
        ])
        .stdout( )
      console.log(out)
    },
    { LogOutput: process.stderr }
  )
```

An example of pseudo-code for the Python development environment is shown below.

```
  import sys
  import anyio
  import dagger
  async def main( ):
    # create Dagger client
    async with
dagger.Connection(dagger.Config(log_output=sys.stderr)) as
client:
      # expose host service on port 3306
      host_srv = client.host( ).service(
        [
          dagger.PortForward(
            backend=3306, frontend=3306,
protocol=dagger.NetworkProtocol.TCP
          )
        ]
      )
      # create MariaDB container
      # with host service binding
      # execute SQL query on host service
      out = await (
        client.container( )
        .from_(“mariadb:10.11.2”)
        .with_service_binding(“db”, host_srv)
        .with_exec(
          [
            “/bin/sh”,
            “-c”,
            “/usr/bin/mysql --user=root --
password=secret --host=db -e ‘SELECT * FROM mysql.user’”,
          ]
        )
        .stdout( )
      )
    print(out)
  anyio.run(main)
```

The aforementioned DAGGER pipeline may create a service that proxies traffic through the host to the configured port. It may then set the service binding on the client container to the host. In another embodiment, the user may connect client containers to Unix sockets on the host instead of TCP.

In one embodiment, the user may persist service state. Another way to avoid relying on the grace period may be to use a cache volume to persist a service's data, as in the following example.

An example of pseudo-code for the Go development environment is shown below.

```
  package main
  import (
    “context”
    “fmt”
    “os”
    “dagger.io/dagger”
  )
  func main( ) {
    ctx := context.Background( )
    // create Dagger client
    client, err := dagger.Connect(ctx,
dagger.WithLogOutput(os.Stderr))
    if err != nil {
      panic(err)
    }
    defer client.Close( )
    // create Redis service container
    redisSrv := client.Container( ).
      From(“redis”).
      WithExposedPort(6379).
      WithMountedCache(“/data”, client.CacheVolume(“my-
redis”)).
      WithWorkdir(“/data”).
      AsService( )
    // create Redis client container
    redisCLI := client.Container( ).
      From(“redis”).
      WithServiceBinding(“redis-srv”, redisSrv).
      WithEntrypoint([ ]string{“redis-cli”, “-h”,
“redis-srv”})
    // set and save value
    redisCLI.
      WithExec([ ]string{“set”, “foo”, “abc”}).
      WithExec([ ]string{“save”}).
      Stdout(ctx)
    // get value
    val, err := redisCLI.
      WithExec([ ]string{“get”, “foo”}).
      Stdout(ctx)
    if err != nil {
      panic(err)
    }
    fmt.Println(val)
  }
```

An example of pseudo-code for the Node.js development environment is shown below.

```
  import { connect, Client } from “@dagger.io/dagger”
  connect (
    async (client: Client) => {
      const redisSrv = client
        .container( )
        .from(“redis”)
        .withExposedPort(6379)
        .withMountedCache(“/data”, client.cacheVolume(“my-
redis”))
        .withWorkdir(“/data”)
        .asService( )
      // create Redis client container
      const redisCLI = client
        .container( )
        .from(“redis”)
        .withServiceBinding(“redis-srv”, redisSrv)
        .withEntrypoint([“redis-cli”, “-h”, “redis-srv”])
      // set and save value
      await redisCLI.withExec([“set”, “foo”,
“abc”]).withExec([“save”]).stdout( )
      // get value
      const val = await redisCLI.withExec([“get”,
“foo”]).stdout( )
      console.log(val)
    },
    { LogOutput: process.stderr }
  )
```

An example of pseudo-code for the Python development environment is shown below.

```
  import sys
  import anyio
  import dagger
  async def main( ):
    # create Dagger client
    async with
dagger.Connection(dagger.Config(log_output=sys.stderr)) as
client :
      # create Redis service container
      redis_srv = (
        client.container( )
        .from_(“redis”)
        .with_exposed_port(6379)
        .with_mounted_cache(“/data”,
client.cache_volume(“my-redis”))
        .with_workdir(“/data”)
        .as_service( )
      )
      # create Redis client container
      redis_cli = (
        client.container( )
        .from(“redis”)
        .with_service_binding(“redis-srv”, redis srv)
        .with_entrypoint([“redis-cli”, “-h”, “redis-
srv”])
      )
      # set and save value
      await redis_cli.with_exec([“set”, “foo”,
“abc”]).with_exec([“save”]).stdout( )
      # get value
      val = await redis_cli.with_exec([“get”,
“foo”]).stdout( )
    print(val)
  anyio.run(main)
```

The above example uses Redis's SAVE command to ensure data is synced. By default, Redis may flush data to disk periodically.

Services may be designed to be expressed as a Directed Acyclic Graph (DAG) with explicit bindings allowing services to be started lazily, just like every other DAG node. In particular embodiments, the user may explicitly manage the lifecycle. The user may explicitly start and stop services in their pipelines. The following is an example which demonstrates explicitly starting a Docker daemon for use in a test suite.

An example of pseudo-code for the Go development environment is shown below.

```
  package main_test
  import (
    ″context″
    ″testing″
    ″dagger.io/dagger″
    ″github.com/stretchr/testify/require″
  )
  func TestFoo(t *testing.T) {
    ctx := context.Background( )
    c, err := dagger.Connect(ctx)
    require.NoError(t, err
    dockerd, err :=
c.Container( ).From(″docker:dind″).AsService( ).Start(ctx)
    require.NoError(t, err)
    // dockerd is now running, and will stay running
    // so you don't have to worry about it restarting
after a 10 second gap
    // then in all of your tests, continue to use an
explicit binding:
    _, err = c.Container( ).From(″golang″).
      WithServiceBinding(″docker″, dockerd).
      WithEnvVariable(″DOCKER_HOST″,
″tcp://docker:2375″).
      WithExec([ ]string{″go″, ″test″, ″./...″}).
      Sync(ctx)
    require.NoError(t, err)
    // or, if you prefer
    // trust ‘Endpoint( )‘ to construct the address
    //
    // note that this has the exact same non-cache-
busting semantics as WithServiceBinding,
    // since hostnames are stable and content-addressed
    //
    // this could be part of the global test suite setup.
    dockerHost, err := dockerd.Endpoint(ctx,
dagger.ServiceEndpointOpts{
      Scheme: ″tcp″,
    })
    require.NoError(t, err)
    _, err = c.Container( ).From(″golang″).
      WithEnvVariable(″DOCKER_HOST″, dockerHost).
      WithExec([ ]string{″go″, ″test″, ″./...″}).
      Sync(ctx)
    require.NoError(t, err)
    // Service.Stop( ) is available to explicitly stop the
service if needed
  }
```

An example of pseudo-code for the Node.js development environment is shown below.

```
  import { connect, Client } from ″@dagger.io/dagger″
  connect(
    async (client: Client) => {
      const dockerd = await client
        .container( )
        .from(″docker:dind″)
        .asService( )
        .start( )
      // dockerd is now running, and will stay running
      // so you don't have to worry about it restarting
after a 10 second gap
      // then in all of your tests, continue to use an
explicit binding:
      const test = await client
        .container( )
        .from(″golang″)
        .withServiceBinding(″docker″, dockerd)
        .withEnvVariable(″DOCKER_HOST″,
″tcp://docker:2375″)
        .withExec([″go″, ″test″, ″./...″])
        .sync( )
      console.log(″test: ″, test)
      // or, if you prefer
      // trust ‘endpoint( )‘ to construct the address
      //
      // note that this has the exact same non-cache-
busting semantics as withServiceBinding,
      // since hostnames are stable and content-addressed
      //
      // this could be part of the global test suite setup.
      const dockerHost = await dockerd.endpoint({ scheme:
″tcp″ })
      const testWithEndpoint = await client
        .container( )
        .from(″golang″)
        .withEnvVariable(″DOCKER_HOST″, dockerHost)
        .withExec([″go″, ″test″, ″./...″])
        .sync( )
      console.log(″testWithEndpoint: ″, testWithEndpoint)
      // service.stop( ) is available to explicitly stop the
service if needed
    },
    { LogOutput: process.stderr }
  )
```

An example of pseudo-code for the Python development environment is shown below.

```
  import sys
  import anyio
  import dagger
  async def main( ):
    # create Dagger client
    async with
dagger.Connection(dagger.Config(log_output=sys.stderr)) as
client:
      dockerd = await
client.container( ).from_(″docker:dind″).as_service( ).start( )
      # dockerd is now running, and will stay running
      # so you don't have to worry about it restarting
after a 10 second gap
      test = await (
        client.container( )
        .from_(″golang″)
    .with_service_binding(″docker″, dockerd)
        .with_env_variable(″DOCKER_HOST″,
″tcp://docker:2375″)
        .with_exec([″go″, ″test″, ″./...″])
        .sync( )
      )
      print(″test: ″ + test)
      # or, if you prefer
      # trust ‘endpoint( )‘ to construct the address
      #
      # note that this has the exact same non-cache-
busting semantics as with_service_binding,
      # since hostnames are stable and content-
addressed
      #
      # this could be part of the global test suite
setup.
      docker_host = await
dockerd.endpoint(scheme=″tcp″)
      test_with_endpoint = await (
        client.container( )
        .from_(″golang″)
        .with_env_variable(″DOCKER_HOST″,
docker_host)
        .with_exec([″go″, ″test″, ″./...″])
        .sync( )
      )
      print(″test_with_endpoint: ″ +
test_with_endpoint)
      # service.stop( ) is available to explicitly stop
the service if needed
  anyio.run(main)
```

The following example demonstrates service containers in action, by creating and binding a MariaDB database service container for use in application unit/integration testing. The application used in this example is Drupal, a popular open-source PHP CMS. Drupal includes a large number of unit tests, including tests that require an active database connection. All Drupal 10.x tests are written and executed using the PHPUnit testing framework. An example of pseudo-code for the Go development environment is shown below.

```
  package main
  import (
    “context”
    “fmt”
    “os”
    “dagger.io/dagger”
  )
  func main( ) {
    ctx := context.Background( )
    // create Dagger client
    client, err := dagger.Connect(ctx,
dagger.WithLogOutput(os.Stderr))
    if err != nil {
      panic(err)
    }
    defer client.Close( )
    // get MariaDB base image
    mariadb := client.Container( ).
      From(“mariadb:10.11.2”).
      WithEnvVariable(“MARIADB_USER”, “user”).
      WithEnvVariable(“MARIADB_PASSWORD”, “password”).
      WithEnvVariable(“MARIADB_DATABASE”, “drupal”).
      WithEnvVariable(“MARIADB_ROOT_PASSWORD”, “root”).
      WithExposedPort(3306).
      AsService( )
    // get Drupal base image
    // install additional dependencies
    drupal := client.Container( ).
      From(“drupal:10.0.7-php8.2-fpm”).
      WithExec([ ]string{“composer”, “require”,
“drupal/core-dev”, “--dev”, “--update-with-all-dependencies”})
    // add service binding for MariaDB
    // run kernel tests using PHPUnit
    test, err := drupal.
      WithServiceBinding(“db”, mariadb).
      WithEnvVariable(“SIMPLETEST_DB”,
“mysql://user:password@db/drupal”).
      WithEnvVariable(“SYMFONY_DEPRECATIONS_HELPER”,
“disabled”).
      WithWorkdir(“/opt/drupal/web/core”).
      WithExec([ ]string{“../../vendor/bin/phpunit”, “-
v”, “--group”, “KernelTests”}).
      Stdout(ctx)
    if err != nil {
      panic(err)
    }
    fmt.Println(test)
  }
```

An example of pseudo-code for the Node.js development environment is shown below.

```
  import { connect, Client } from “@dagger.io/dagger”
  connect(
    async (client: Client) => {
      // get MariaDB base image
      const mariadb = client
        .container( )
        .from(“mariadb:10.11.2”)
        .withEnvVariable(“MARIADB_USER”, “user”)
        .withEnvVariable(“MARIADB_PASSWORD”, “password”)
        .withEnvVariable(“MARIADB_DATABASE”, “drupal”)
        .withEnvVariable(“MARIADB_ROOT_PASSWORD”, “root”)
        .withExposedPort(3306)
        .asService( )
      // get Drupal base image
      // install additional dependencies
      const drupal = client
        .container( )
        .from(“drupal:10.0.7-php8.2-fpm”)
        .withExec([
          “composer”,
          “require”,
          “drupal/core-dev”,
          “--dev”,
          “--update-with-all-dependencies”,
        ])
      // add service binding for MariaDB
      // run unit tests using PHPUnit
      const test = await drupal
        .withServiceBinding(“db”, mariadb)
        .withEnvVariable(“SIMPLETEST_DB”,
“mysql://user:password@db/drupal”)
        .withEnvVariable(“SYMFONY_DEPRECATIONS_HELPER”,
“disabled”)
        .withWorkdir(“/opt/drupal/web/core”)
        .withExec([“../../vendor/bin/phpunit”, “-v”, “--
group”, “KernelTests”])
        .stdout( )
      // print ref
      console.log(test)
    },
    { LogOutput: process.stderr }
  )
```

An example of pseudo-code for the Python development environment is shown below.

```
  import sys
  import anyio
  import dagger
  async def main( ):
    # create Dagger client
    async with
dagger.Connection(dagger.Config(log_output=sys.stderr)) as
client:
      # get MariaDB base image
      mariadb = (
        client.container( )
        .from_(“mariadb:10.11.2”)
        .with_env_variable(“MARIADB_USER”, “user”)
        .with_env_variable(“MARIADB_PASSWORD”,
“password”)
        .with_env_variable(“MARIADB_DATABASE”,
“drupal”)
        .with_env_variable(“MARIADB_ROOT_PASSWORD”,
“root”)
        .with_exposed_port(3306)
        .as_service( )
      )
      # get Drupal base image
      # install additional dependencies
      drupal = (
        client.container( )
        .from_(“drupal:10.0.7-php8.2-fpm”)
        .with_exec(
        [
            “composer”,
            “require”,
            “drupal/core-dev”,
            “--dev”,
            “--update-with-all-dependencies”,
          ]
        )
      )
      # add service binding for MariaDB
      # run unit tests using PHPUnit
      test = await (
        drupal.with_service_binding(“db”, mariadb)
        .with_env_variable(“SIMPLETEST_DB”,
“mysql://user:password@db/drupal”)
.with_env_variable(“SYMFONY_DEPRECATIONS_HELPER”,
“disabled”)
        .with_workdir(“/opt/drupal/web/core”)
        .with_exec([“../../vendor/bin/phpunit”, “-v”,
“--group”, “KernelTests”])
        .stdout( )
      )
    print(test)
  anyio.run(main)
```

The above example begins by creating a MariaDB service container and initializing a new MariaDB database. It then creates a Drupal container (client) and installs required dependencies into it. Next, it adds a binding for the MariaDB service (db) in the Drupal container and sets a container environment variable (SIMPLETEST_DB) with the database DSN. Finally, it runs Drupal's kernel tests (which require a database connection) using PHPUnit and prints the test summary to the console.

Explicitly specifying the service container port with WithExposedPort( ) (Go), withExposedPort( ) (Node.js) or with_exposed_port( ) (Python) may be particularly important here. Without it, DAGGER may start the service container and immediately allow access to service clients. With it, DAGGER may wait for the service to be listening first. In one embodiment, the user may check how service binding works for container services in the background. An example of pseudo-code for the Go development environment is shown below.

```
  package main
  import (
    “context”
    “fmt”
    “os”
    “dagger.io/dagger”
  )
  func main( ) {
    ctx := context.Background( )
    // create Dagger client
    client, err := dagger.Connect(ctx,
dagger.WithLogOutput(os.Stderr))
    if err != nil {
      panic(err)
    }
    defer client.Close( )
    // create Redis service container
    redisSrv := client.Container( ).
      From(“redis”).
      WithExposedPort(6379).
      AsService( )
    // create Redis client container
    redisCLI := client.Container( ).
      From(“redis”).
      WithServiceBinding(“redis-srv”, redisSrv).
      WithEntrypoint([ ]string{“redis-cli”, “-h”,
“redis-srv”})
    // send ping from client to server
    ping := redisCLI.WithExec([ ]string{“ping”})
    val, err := ping.
      Stdout(ctx)
    if err != nil {
      panic(err)
    }
    fmt.Println(val)
  }
```

An example of pseudo-code for the Node.js development environment is shown below.

```
  import { connect, Client } from “@dagger.io/dagger”
  connect(
    async (client: Client) => {
      // create Redis service container
      const redisSrv = client
        .container( )
        .from(“redis”)
        .withExposedPort(6379)
        .asService( )
      // create Redis client container
      const redisCLI = client
        .container( )
        .from(“redis”)
        .withServiceBinding(“redis-srv”, redisSrv)
        .withEntrypoint([“redis-cli”, “-h”, “redis-srv”])
      // send ping from client to server
      const val = await
redisCLI.withExec([“ping”]).stdout( )
      console.log(val)
    },
    { LogOutput: process.stderr }
  )
```

An example of pseudo-code for the Python development environment is shown below.

```
  import sys
  import anyio
  import dagger
  async def main( ):
    # create Dagger client
    async with
dagger.Connection(dagger.Config(log_output=sys.stderr)) as
client:
      # create Redis service container
      redis_srv = (
client.container( ).from_(“redis”).with_exposed_port(6379).as_ser
vice( )
      )
      # create Redis client container
      redis_cli = (
        client.container( )
        .from_(“redis”)
        .with_service_binding(“redis-srv”, redis_srv)
        .with_entrypoint([“redis-cli”, “-h”, “redis-
srv”])
      )
      # send ping from client to server
      ping = await
redis_cli.with_exec([“ping”]).stdout( )
    print(ping)
  anyio.run(main)
```

For the above example, here is what happens on the last line. First, the client requests the ping container's stdout, which requires the container to run. DAGGER then sees that the ping container has a service binding, redis_srv. DAGGER then starts the redis_srv container, which recurses into this same process. DAGGER then waits for health checks to pass against redis_srv. DAGGER further runs the ping container with the redis-srv alias magically added to/etc/hosts. In one embodiment, DAGGER may cancel each service run after a 10 second grace period to avoid frequent restarts.

Services may be based on containers, but they may run a little differently. Whereas regular containers in DAGGER are de-duplicated across the entire DAGGER Engine, service containers may be only de-duplicated within a DAGGER client session. This means that if the user run separate DAGGER sessions that use the exact same services, they may each get their own “instance” of the service. This process may be carefully tuned to preserve caching at each client call-site, while prohibiting “cross-talk” from one DAGGER session's client to another DAGGER session's service.

Content-addressed services may be convenient. The user does not have to determine names and maintain instances of services. Instead, the user may use them by value. The user also does not have to manage the state of the service. Instead, the user may trust that it will be running when needed and stopped when not. If the user needs multiple instances of a service, the user may attach something unique to each one, such as an instance ID.

The following is a more detailed client-server example of running commands against a Redis service.

An example of pseudo-code for the Go development environment is shown below.

```
  package main
  import (
    “context”
    “fmt”
    “os”
    “dagger.io/dagger”
  )
  func main( ) {
    ctx := context.Background( )
    // create Dagger client
    client, err := dagger.Connect(ctx,
dagger.WithLogOutput(os.Stderr))
    if err != nil {
      panic(err)
    }
    defer client.Close( )
    // create Redis service container
    redisSrv := client.Container( ).
      From(“redis”).
      WithExposedPort(6379).
      AsService( )
    // create Redis client container
    redisCLI := client.Container( ).
      From(“redis”).
      WithServiceBinding(“redis-srv”, redisSrv).
      WithEntrypoint([ ]string{“redis-cli”, “-h”,
“redis-srv”})
    // set value
    setter, err1 := redisCLI.
      WithExec([ ]string{“set”, “foo”, “abc”}).
      Stdout(ctx)
    if err1 != nil {
      panic(err1)
    }
    fmt.Println(setter)
    // get value
    getter, err2 := redisCLI.
      WithExec([ ]string{“get”, “foo”}).
      Stdout(ctx)
    if err2 != nil {
      panic(err2)
    }
    fmt.Println(getter)
  }
```

An example of pseudo-code for the Node.js development environment is shown below.

```
  import { connect, Client } from “@dagger.io/dagger”
  connect(
    async (client: Client) => {
      // create Redis service container
      const redisSrv = client
        .container( )
        .from(“redis”)
        .withExposedPort(6379)
        .asService( )
      // create Redis client container
      const redisCLI = client
        .container( )
        .from(“redis”)
        .withServiceBinding(“redis-srv”, redisSrv)
        .withEntrypoint([“redis-cli”, “-h”, “redis-srv”])
      // set value
      const setter = await redisCLI.withExec([“set”, “foo”,
“abc”]).stdout( )
      console.log(setter)
      const getter = await redisCLI.withExec([“get”,
“foo”]).stdout( )
      console.log(getter)
    },
    { LogOutput: process.stderr }
  )
```

An example of pseudo-code for the Python development environment is shown below.

```
  import sys
  import anyio
  import dagger
  async def main( ):
    # create Dagger client
    async with
dagger.Connection(dagger.Config(log_output=sys.stderr)) as
client:
      # create Redis service container
      redis_srv = (
client.container( ).from_(“redis”).with_exposed_port(6379).as_ser
vice( )
      )
      # create Redis client container
      redis_cli = (
        client.container( )
        .from_(“redis”)
        .with_service_binding(“redis-srv”, redis_srv)
        .with_entrypoint([“redis-cli”, “-h”, “redis-
srv”])
      )
      # set value
      setter = await redis_cli.with_exec([“set”, “foo”,
“abc”]).stdout( )
      # get value
      getter = await redis_cli.with_exec([“get”,
“foo”]).stdout( )
    print(setter)
    print(getter)
  anyio.run(main)
```

The above example relies on the 10-second grace period, which the user may avoid. It may be better to chain both commands together, which ensures that the service stays running for both. An example of pseudo-code for the Go development environment is shown below.

```
  package main
  import (
    “context”
    “fmt”
    “os”
    “dagger.io/dagger”
  )
  func main( ) {
    ctx := context.Background( )
    // create Dagger client
    client, err := dagger.Connect(ctx,
dagger.WithLogOutput(os.Stderr))
    if err != nil {
      panic(err)
    }
    defer client.Close( )
    // create Redis service container
    redisSrv := client.Container( ).
      From(“redis”).
      WithExposedPort(6379).
      AsService( )
    // create Redis client container
    redisCLI := client.Container( ).
      From(“redis”).
      WithServiceBinding(“redis-srv”, redisSrv).
      WithEntrypoint([ ]string{“redis-cli”, “-h”,
“redis-srv”})
    // set and get value
    val, err := redisCLI.
      WithExec([ ]string{“set”, “foo”, “abc”}).
      WithExec([ ]string{“get”, “foo”}).
      Stdout(ctx)
    if err != nil {
      panic(err)
    }
    fmt.Println(val)
  }
```

An example of pseudo-code for the Node.js development environment is shown below.

```
import { connect, Client } from “@dagger.io/dagger”
connect(
  async (client: Client) => {
    // create Redis service container
    const redisSrv = client
      .container( )
      .from(“redis”)
      .withExposedPort(6379)
      .asService( )
    // create Redis client container
    const redisCLI = client
      .container( )
      .from(“redis”)
      .withServiceBinding(“redis-srv”, redisSrv)
      .withEntrypoint([“redis-cli”, “-h”, “redis-srv”])
    // set and get value
    const val = await redisCLI
      .withExec([“set”, “foo”, “abc”])
      .withExec([“get”, “foo”])
      .stdout( )
    console.log(val)
  },
  { LogOutput: process.stderr }
)
```

An example of pseudo-code for the Python development environment is shown below.

```
  import sys
  import anyio
  import dagger
  async def main( ):
    # create Dagger client
    async with
dagger.Connection(dagger.Config(log_output=sys.stderr)) as
client:
      # create Redis service container
      redis_srv = (
client.container( ).from_(“redis”).with_exposed_port(6379).as_ser
vice( )
      )
      # create Redis client container
      redis_cli = (
        client.container( )
        .from_(“redis”)
        .with_service_binding(“redis-srv”, redis_srv)
        .with_entrypoint([“redis-cli”, “-h”, “redis-
srv”])
      )
      # set and get value
      val = await (
        redis_cli.with_exec([“set”, “foo”, “abc”])
        .with_exec([“get”, “foo”])
        .stdout( )
      )
    print(val)
  anyio.run(main)
```

For the above example, depending on the 10-second grace period may be risky because there are many factors which could cause a 10-second delay between calls to DAGGER, such as excessive CPU load, high network latency between the client and DAGGER, or DAGGER operations that require a variable amount of time to process.

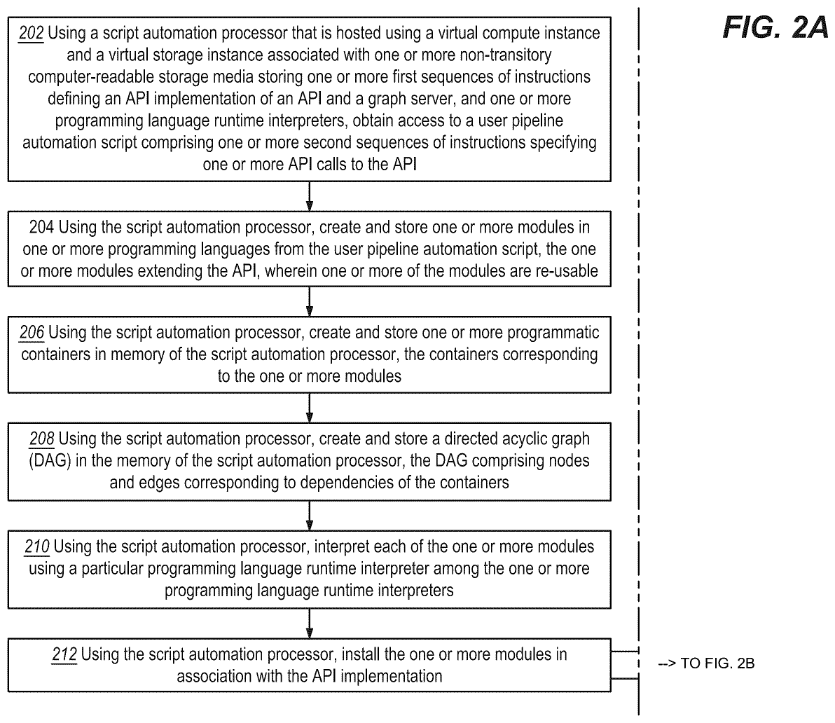

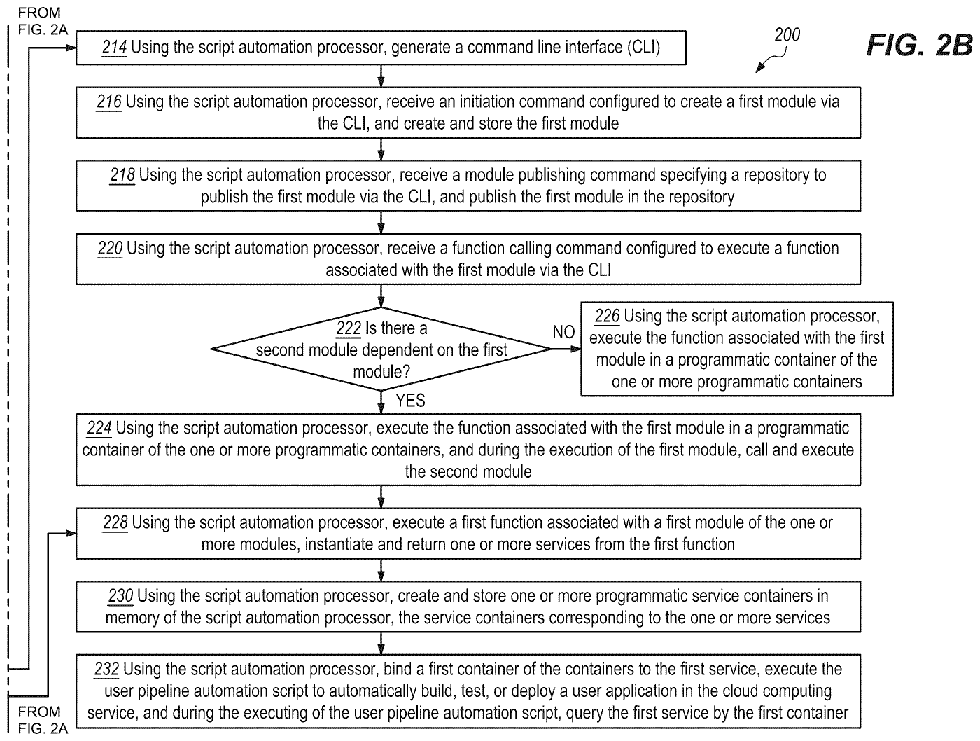

FIG. 2A and FIG. 2B illustrates a computer-implemented process of creating and instantiating modules for a user pipeline automation script in one embodiment. FIG. 2A and FIG. 2B and each other flow diagram herein are intended to illustrate the functional level at which skilled persons, in the art to which this disclosure pertains, communicate with one another to describe and implement algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

Referring first to FIG. 2A, in an embodiment, process 200 initiates at step 202, in which a computer system is programmed to obtain access to a user pipeline automation script comprising one or more second sequences of instructions specifying one or more API calls to the API. Step 202 can execute using a script automation processor 104 that is hosted using a virtual compute instance and a virtual storage instance associated with the one or more non-transitory computer-readable storage media storing one or more first sequences of instructions defining an API implementation of an API and a graph server, and one or more programming language runtime interpreters.

At step 204, the computer system is programmed to, using the script automation processor 104, create and store one or more modules in one or more programming languages from the user pipeline automation script, the one or more modules extending the API, wherein one or more of the modules are reusable.

At step 206, the computer system is programmed to, using the script automation processor 104, create and store one or more programmatic containers in memory of the script automation processor 104, the containers corresponding to the one or more modules.

At step 208, the computer system is programmed to, using the script automation processor 104, create and store a directed acyclic graph (DAG) in the memory of the script automation processor 104, the DAG comprising nodes and edges corresponding to dependencies of the containers.

At step 210, the computer system is programmed to, using the script automation processor 104, interpret each of the one or more modules using a particular programming language runtime interpreter among the one or more programming language runtime interpreters.

At step 212, the computer system is programmed to, using the script automation processor 104, install the one or more modules in association with the API implementation.

Referring now to FIG. 2B, after step 212, process 200 may proceed with two different flows. In one embodiment, process 200 proceeds to step 214. At step 214, the computer system is programmed to, using the script automation processor 104, generate a command line interface (CLI).

At step 216, the computer system is programmed to, using the script automation processor 104, receive an initiation command configured to create a first module via the CLI and create and store the first module.

At step 218, the computer system is programmed to, using the script automation processor 104, receive a module publishing command specifying a repository to publish the first module via the CLI and publish the first module in the repository.

At step 220, the computer system is programmed to, using the script automation processor 104, receive a function calling command configured to execute a function associated with the first module via the CLI.

At step 222, the computer system is programmed to, using the script automation processor 104, determine whether a second module is dependent on the first module. If there is a second module dependent on the first module, process 200 proceeds to step 224, where the computer system is programmed to, using the script automation processor 104, execute the function associated with the first module in a programmatic container of the one or more programmatic containers, and during the execution of the first module, call and execute the second module. If there is not a second module dependent on the first module, process 200 proceeds to step 226, where the computer system is programmed to, using the script automation processor 104, execute the function associated with the first module in a programmatic container of the one or more programmatic containers.

In another embodiment, after step 212, process 200 proceeds to step 228. At step 228, the computer system is programmed to, using the script automation processor 104, execute a first function associated with a first module of the one or more modules, instantiate and return one or more services from the first function.

At step 230, the computer system is programmed to, using the script automation processor 104, create and store one or more programmatic service containers in memory of the script automation processor 104, the service containers corresponding to the one or more services.

At step 232, the computer system is programmed to, using the script automation processor 104, bind a first container of the containers to the first service, execute the user pipeline automation script to automatically build, test, or deploy a user application in the cloud computing service, and during the executing of the user pipeline automation script, query the first service by the first container.

### 2.2.3 Exploring the API

Because the API implementations 106 expose API calls using GRAPHQL interface code, any GRAPHQL-compatible client can interact directly with the API implementations 106. For example, a GRAPHQL-compatible browser can connect to and query the API implementations 106 to investigate the behavior of the implementations and calls. Thus, the use of GRAPHQL as an API interface mechanism, which is unique to this disclosure, enables workflow developers to experiment with pipelines and/or execute pipelines for special purposes.

### 2.2.4 Writing An API Extension

User pipeline automation script 110 can define one or more API extensions 116, which script automation processor 104 is programmed to read and store as extension code 107 with links to appropriate calls in API implementations 106. Extensions also can extend data types that the API implementations declare or use. By using extensions, as further described, workflow developers can integrate enterprise-specific logic into the API of the script automation processor 104 to make that logic available to other developers and to permit shorter, more convenient references to reusable logic. This approach moves enterprise-specific script code out of the body of the user pipeline automation script and into a location that the script automation processor 104 manages, simplifying references to and use of the code.

Extensions can be appropriate in several cases. First, an extension is useful when a workflow is growing larger and more complex and is becoming harder to develop. Second, an extension is useful when the same logic is duplicated across workflows, and there's no practical way to share it. Writing an extension is more advanced than writing a workflow because an extension is structured as a GRAPHQL client AND also implements some parts of a GRAPHQL server 109. As with workflows, extensions can be written in any language, and written easily using references to SDK interface 118. Unlike workflows, extensions are fully sandboxed and cannot access the host system.

Embodiments offer numerous improvements and benefits over prior practice. The DAG 130 of containers can reflect application dependencies, and the interoperation of script automation processor 104 with the container build utility 102 frees the developer from the details of managing containers.

### 3. Implementation Example—Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

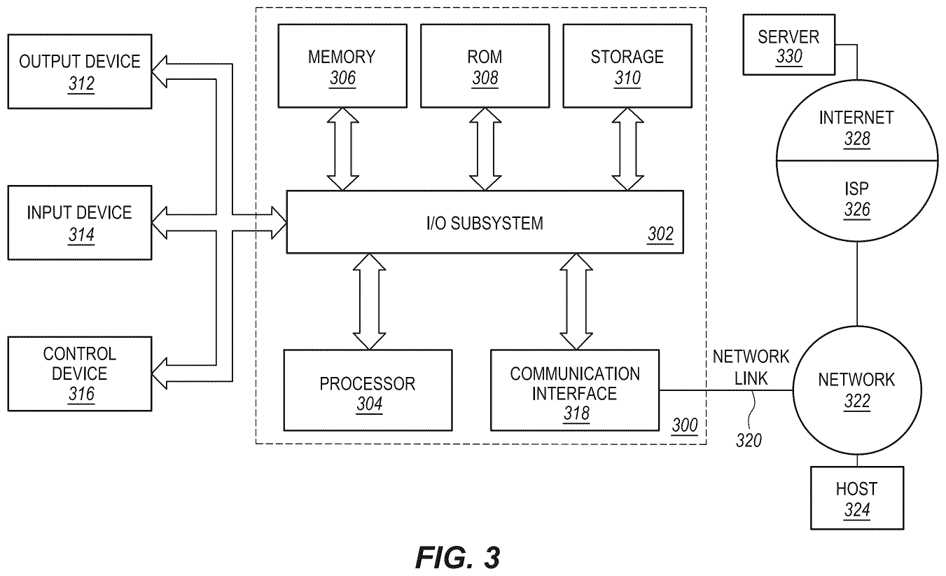

FIG. 3 is a block diagram that illustrates an example computer system with which an embodiment may be implemented. In the example of FIG. 3, a computer system 300 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 300 includes an input/output (I/O) subsystem 302 which may include a bus and/or other communication mechanisms for communicating information and/or instructions between the components of the computer system 300 over electronic signal paths. The I/O subsystem 302 may include an I/O controller, a memory controller, and at least one I/O port. The electronic signal paths are represented schematically in the drawings, for example as lines, unidirectional arrows, or bidirectional arrows.

At least one hardware processor 304 is coupled to I/O subsystem 302 for processing information and instructions. Hardware processor 304 may include, for example, a general-purpose microprocessor or microcontroller and/or a special-purpose microprocessor such as an embedded system or a graphics processing unit (GPU) or a digital signal processor or ARM processor. Processor 304 may comprise an integrated arithmetic logic unit (ALU) or may be coupled to a separate ALU.

Computer system 300 includes one or more units of memory 306, such as a main memory, which is coupled to I/O subsystem 302 for electronically digitally storing data and instructions to be executed by processor 304. Memory 306 may include volatile memory such as various forms of random-access memory (RAM) or another dynamic storage device. Memory 306 also may be used for storing temporary variables or other intermediate information during the execution of instructions to be executed by processor 304. Such instructions, when stored in non-transitory computer-readable storage media accessible to processor 304, can render computer system 300 into a special-purpose machine that is customized to perform the operations specified in the instructions.

Computer system 300 further includes non-volatile memory such as read-only memory (ROM) 308 or other static storage devices coupled to I/O subsystem 302 for storing information and instructions for processor 304. The ROM 308 may include various forms of programmable ROM (PROM) such as erasable PROM (EPROM) or electrically erasable PROM (EEPROM). A unit of persistent storage 310 may include various forms of non-volatile RAM (NVRAM), such as FLASH memory, or solid-state storage, magnetic disk or optical disks such as CD-ROM or DVD-ROM and may be coupled to I/O subsystem 302 for storing information and instructions. Storage 310 is an example of a non-transitory computer-readable medium that may be used to store instructions and data which when executed by the processor 304 cause performing computer-implemented methods to execute the techniques herein.

The instructions in memory 306, ROM 308 or storage 310 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation layer, application layer, and data storage layer such as a relational database system using a structured query language (SQL) or no SQL, an object store, a graph database, a flat-file system, or other data storage.

Computer system 300 may be coupled via I/O subsystem 302 to at least one output device 312. In one embodiment, output device 312 is a digital computer display. Examples of a display that may be used in various embodiments include a touch screen display or a light-emitting diode (LED) display or a liquid crystal display (LCD) or an e-paper display. Computer system 300 may include another type(s) of output devices 312, alternatively or in addition to a display device. Examples of other output devices 312 include printers, ticket printers, plotters, projectors, sound cards or video cards, speakers, buzzers or piezoelectric devices or other audible devices, lamps or LED or LCD indicators, haptic devices, actuators, or servos.

At least one input device 314 is coupled to I/O subsystem 302 for communicating signals, data, command selections, or gestures to processor 304. Examples of input devices 314 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 316, which may perform cursor control or other automated control functions such as navigation in a graphical interface on a display screen, alternatively or in addition to input functions. Control device 316 may be a touchpad, a mouse, a trackball, or cursor direction keys for communicating direction information and command selections to processor 304 and for controlling cursor movement on display 312. The input device may have at least two degrees of freedom in two axes, a first axis (for example, x) and a second axis (for example, y), that allows the device to specify positions in a plane. Another type of input device is a wired, wireless, or optical control device such as a joystick, wand, console, steering wheel, pedal, gearshift mechanism, or another type of control device. An input device 314 may include a combination of multiple different input devices, such as a video camera and a depth sensor.

In another embodiment, computer system 300 may comprise an internet of things (IoT) device in which one or more of the output device 312, input device 314, and control device 316 are omitted. Or, in such an embodiment, the input device 314 may comprise one or more cameras, motion detectors, thermometers, microphones, seismic detectors, other sensors or detectors, measurement devices or encoders and the output device 312 may comprise a special-purpose display such as a single-line LED or LCD display, one or more indicators, a display panel, a meter, a valve, a solenoid, an actuator or a servo.

When computer system 300 is a mobile computing device, input device 314 may comprise a global positioning system (GPS) receiver coupled to a GPS module that is capable of triangulating to a plurality of GPS satellites, determining and generating geo-location or position data such as latitude-longitude values for a geophysical location of the computer system 300. Output device 312 may include hardware, software, firmware, and interfaces for generating position reporting packets, notifications, pulse or heartbeat signals, or other recurring data transmissions that specify a position of the computer system 300, alone or in combination with other application-specific data, directed toward host 324 or server 330.

Computer system 300 may implement the techniques described herein using customized hard-wired logic, at least one ASIC or FPGA, firmware, and/or program instructions or logic which when loaded and used or executed in combination with the computer system causes or programs the computer system to operate as a special-purpose machine. According to one embodiment, the techniques herein are performed by computer system 300 in response to processor 304 executing at least one sequence of at least one instruction contained in main memory 306. Such instructions may be read into main memory 306 from another storage medium, such as storage 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 310. Volatile media includes dynamic memory, such as memory 306. Common forms of storage media include, for example, a hard disk, solid-state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 302. Transmission media can also take the form of acoustic or light waves, such as those generated during radio-wave and infra-red data communications.

Various forms of media may be involved in carrying at least one sequence of at least one instruction to processor 304 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 300 can receive the data on the communication link and convert the data to a format that can be read by computer system 300. For instance, a receiver such as a radio frequency antenna or an infrared detector can receive the data carried in a wireless or optical signal and appropriate circuitry can provide the data to I/O subsystem 302 and place the data on a bus. I/O subsystem 302 carries the data to memory 306, from which processor 304 retrieves and executes the instructions. The instructions received by memory 306 may optionally be stored on storage 310 either before or after execution by processor 304.

Computer system 300 also includes a communication interface 318 coupled to bus 302. Communication interface 318 provides a two-way data communication coupling to a network link(s) 320 that are directly or indirectly connected to at least one communication network, such as a network 322 or a public or private cloud on the Internet. For example, communication interface 318 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. Network 322 broadly represents a local area network (LAN), wide-area network (WAN), campus network, internetwork, or any combination thereof. Communication interface 318 may comprise a LAN card to provide a data communication connection to a compatible LAN or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 318 sends and receives electrical, electromagnetic, or optical signals over signal paths that carry digital data streams representing various types of information.

Network link 320 typically provides electrical, electromagnetic, or optical data communication directly or through at least one network to other data devices, using, for example, satellite, cellular, Wi-Fi, or BLUETOOTH technology. For example, network link 320 may provide a connection through network 322 to a host computer 324.

Furthermore, network link 320 may provide a connection through network 322 or to other computing devices via internetworking devices and/or computers that are operated by an Internet Service Provider (ISP) 326. ISP 326 provides data communication services through a worldwide packet data communication network represented as internet 328. A server computer 330 may be coupled to internet 328. Server 330 broadly represents any computer, data center, virtual machine, or virtual computing instance with or without a hypervisor, or computer executing a containerized program system such as DOCKER or KUBERNETES. Server 330 may represent an electronic digital service that is implemented using more than one computer or instance and that is accessed and used by transmitting web services requests, uniform resource locator (URL) strings with parameters in HTTP payloads, API calls, app services calls, or other service calls. Computer system 300 and server 330 may form elements of a distributed computing system that includes other computers, a processing cluster, server farm, or other organization of computers that cooperate to perform tasks or execute applications or services. Server 330 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 330 may comprise a web application server that hosts a presentation layer, application layer, and data storage layer such as a relational database system using a structured query language (SQL) or no SQL, an object store, a graph database, a flat-file system or other data storage.

Computer system 300 can send messages and receive data and instructions, including program code, through the network(s), network link 320 and communication interface 318. In the Internet example, a server 330 might transmit a requested code for an application program through Internet 328, ISP 326, local network 322 and communication interface 318. The received code may be executed by processor 304 as it is received, and/or stored in storage 310, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 304. While each processor 304 or core of the processor executes a single task at a time, computer system 300 may be programmed to implement multitasking to allow each processor to switch between tasks that are being executed without having to wait for each task to finish. In an embodiment, switches may be performed when tasks perform input/output operations when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer system comprising:
a script automation processor; and
a virtual compute instance and a virtual storage instance associated with one or more non-transitory computer-readable storage media storing one or more first sequences of instructions defining an API implementation of an API, a graph server, and one or more programming language runtime interpreters, and which, when executed using the virtual compute instance, cause the virtual compute instance to execute:
obtaining access to a user pipeline automation script comprising one or more second sequences of instructions specifying one or more API calls to the API;
executing the script automation processor;
creating and storing one or more modules in one or more programming languages from the user pipeline automation script, the one or more modules extending the API, wherein one or more of the modules are re-usable;
creating and storing one or more programmatic containers in memory of the script automation processor, the containers corresponding to the one or more modules;
creating and storing a directed acyclic graph (DAG) in the memory of the script automation processor, the DAG comprising nodes and edges corresponding to dependencies of the containers;
interpreting each of the one or more modules using a particular programming language runtime interpreter among the one or more programming language runtime interpreters; and
installing the one or more modules in association with the API implementation.

2. The computer system of claim 1, the script automation processor further comprising the first sequences of instructions which, when executed using the virtual compute instance, cause the virtual compute instance to execute:
generating a command line interface (CLI);
receiving, via the CLI, an initiation command configured to create a first module; and
creating and storing the first module.

3. The computer system of claim 2, the script automation processor further comprising the first sequences of instructions which, when executed using the virtual compute instance, cause the virtual compute instance to execute:
receiving, via the CLI, a function calling command configured to execute a function associated with the first module; and
executing the function associated with the first module in a programmatic container of the one or more programmatic containers.

4. The computer system of claim 2, the script automation processor further comprising the first sequences of instructions which, when executed using the virtual compute instance, cause the virtual compute instance to execute:
receiving, via the CLI, a modification command configured to modify the first module;
modifying the first module; and
receiving, via the CLI, a synchronization command configured to reload the first module.

5. The computer system of claim 2, a function associated with the first module being configured to take and return data objects associated with a plurality of types.

6. The computer system of claim 2, the script automation processor further comprising the first sequences of instructions which, when executed using the virtual compute instance, cause the virtual compute instance to execute:
receiving, via the CLI, a module calling command configured to add a dependency of a second module to the first module;
executing the first module; and
during the execution of the first module, calling and executing the second module.

7. The computer system of claim 2, wherein the first module is stored in two or more repositories, the script automation processor further comprising the first sequences of instructions which, when executed using the virtual compute instance, cause the virtual compute instance to execute:
receiving, via the CLI, a function calling command specifying a first repository of the two or more repositories;
consuming the first module from the first repository; and
executing the first module.

8. The computer system of claim 2, the script automation processor further comprising the first sequences of instructions which, when executed using the virtual compute instance, cause the virtual compute instance to execute:
receiving, via the CLI, a module publishing command specifying a repository to publish the first module; and
publishing the first module in the repository.

9. The computer system of claim 2, wherein a first function is associated with the first module, wherein the first function is configured to return custom objects defining one or more second functions.

10. The computer system of claim 9, the script automation processor further comprising the first sequences of instructions which, when executed using the virtual compute instance, cause the virtual compute instance to execute:
receiving, via the CLI, a function calling command configured to execute the first function;
executing the first function; and
during the execution of the first function, calling and executing the one or more second functions.

11. The computer system of claim 1, wherein at least a first function is associated with a first module of the one or more modules, the script automation processor further comprising the first sequences of instructions which, when executed using the virtual compute instance, cause the virtual compute instance to execute:
executing the first function; and
instantiating and returning one or more services from the first function.

12. The computer system of claim 11, the script automation processor further comprising the first sequences of instructions which, when executed using the virtual compute instance, cause the virtual compute instance to execute:
creating and storing one or more programmatic service containers in memory of the script automation processor, the service containers corresponding to the one or more services.

13. The computer system of claim 12, wherein each of the service containers comprises a service hostname configured for querying the corresponding service container.

14. The computer system of claim 12, wherein each of the service containers comprises one or more ports configured to expose the corresponding service to a host.

15. The computer system of claim 14, the script automation processor further comprising the first sequences of instructions which, when executed using the virtual compute instance, cause the virtual compute instance to execute:
receiving, via one or more of the ports, a request to use the first service from a client on the host; and
executing the first service.

16. The computer system of claim 12, the script automation processor further comprising the first sequences of instructions which, when executed using the virtual compute instance, cause the virtual compute instance to execute:
binding a first service of the services executing in a first service container of the service container to a client container; and
automatically starting the first service when the client container executes.

17. The computer system of claim 12, wherein a first service of the services executes on a host, the script automation processor further comprising the first sequences of instructions which, when executed using the virtual compute instance, cause the virtual compute instance to execute:
binding a first container of the containers to the first service;
executing the user pipeline automation script to automatically build, test, or deploy a user application in a cloud computing service; and
during the executing of the user pipeline automation script, querying the first service by the first container.

18. The computer system of claim 12, the script automation processor further comprising the first sequences of instructions which, when executed using the virtual compute instance, cause the virtual compute instance to execute creating and storing, in the DAG, nodes corresponding the services and edges corresponding to bindings associated with the services.

19. The computer system of claim 1, the script automation processor further comprising two or more programming language runtime interpreters, wherein each programming language runtime interpreter among the two or more programming language runtime interpreters is programmed to interpret a different programming language used in each of the one or more modules.

20. The computer system of claim 1, wherein the script automation processor further comprises the second sequences of instructions which, when executed using the virtual compute instance, cause the virtual compute instance to execute:
executing the user pipeline automation script to automatically build, test, or deploy a user application in a cloud computing service; and
during the executing, based on the user pipeline automation script, invoking one or more of the one or more modules as part of automatically building, testing, or deploying the user application in the cloud computing service.

21. The computer system of claim 1, wherein the user pipeline automation script further comprises at least one reference to a software development kit (SDK), and wherein the script automation processor comprises an SDK interface responsive to function invocations via the at least one reference.

22. A computer-implemented method comprising:
using a script automation processor that is hosted using a virtual compute instance and a virtual storage instance associated with one or more non-transitory computer-readable storage media storing one or more first sequences of instructions defining an API implementation of an application programming interface (API), a graph server, and one or more programming language runtime interpreters, obtaining access to a user pipeline automation script comprising one or more second sequences of instructions specifying one or more API calls to the API;
using the script automation processor, creating and storing one or more modules in one or more programming languages from the user pipeline automation script, the one or more modules extending the API, wherein one or more of the modules are re-usable;
using the script automation processor, creating and storing one or more programmatic containers in memory of the script automation processor, the containers corresponding to the one or more modules;
using the script automation processor, creating and storing a directed acyclic graph (DAG) in the memory of the script automation processor, the DAG comprising nodes and edges corresponding to dependencies of the containers;
using the script automation processor, interpreting each of the one or more modules using a particular programming language runtime interpreter among the one or more programming language runtime interpreters; and
using the script automation processor, installing the one or more modules in association with the API implementation.

23. One or more non-transitory computer-readable storage media storing one or more sequences of instructions which, when executed using one or more processors, cause the one or more processors to:
using a script automation processor that is hosted using a virtual compute instance and a virtual storage instance associated with one or more non-transitory computer-readable storage media storing one or more first sequences of instructions defining an API implementation of an application programming interface (API), a graph server, and one or more programming language runtime interpreters, obtaining access to a user pipeline automation script comprising one or more second sequences of instructions specifying one or more API calls to the API;
using the script automation processor, creating and storing one or more modules in one or more programming languages from the user pipeline automation script, the one or more modules extending the API, wherein one or more of the modules are re-usable;
using the script automation processor, creating and storing one or more programmatic containers in memory of the script automation processor, the containers corresponding to the one or more modules;
using the script automation processor, creating and storing a directed acyclic graph (DAG) in the memory of the script automation processor, the DAG comprising nodes and edges corresponding to dependencies of the containers;
using the script automation processor, interpreting each of the one or more modules using a particular programming language runtime interpreter among the one or more programming language runtime interpreters; and
using the script automation processor, installing the one or more modules in association with the API implementation.
